(19) United States
(12) Patent Application Publication
(10) Pub. No.: US 2026/0219404 A1
(43) Pub. Date: Jul. 30, 2026

(54) BEND RESTRICTORS AND RADIATION DETECTORS INCLUDING THE SAME

(71) Applicant: VAREX IMAGING CORPORATION, Salt Lake City, UT (US)

(72) Inventors: David Henderson Owen, Richmond, UT (US); Xiaoyang Shen, Midvale, UT (US); Jeff Adams, Huntsville, UT (US); Marcelo C. Costa, Draper, UT (US)

(21) Appl. No.: 19/387,407

(22) Filed: Nov. 12, 2025

Related U.S. Application Data
(60) Provisional application No. 63/749,131, filed on Jan. 24, 2025.

(51) Int. Cl. G01T 1/20

(52) U.S. Cl. CPC G01T 1/20188; G01T 1/20181

(57) ABSTRACT

Bend restrictors and radiation detectors including the same are disclosed. A radiation detector can include an imaging array configured to detect incident radiation in an active area and a bend restrictor coupled to the imaging array. The bend restrictor can at least partially overlap the active area.

### CROSS-REFERENCE TO RELATED APPLICATIONS

This application claims priority to U.S. Patent Application No. 63/749,131, filed 24 January 2025, the entire disclosure of which is hereby incorporated by reference.

### FIELD

The described embodiments relate generally to radiation detectors (e.g., x-ray detectors), and more particularly, to radiation detectors including bend restrictors that limit or predictably control the bending of the radiation detectors.

### BACKGROUND

Radiation detectors can be used to generate two-dimensional or three-dimensional images or video in response to incident radiation. Radiation detectors can be used in a variety of contexts, including medical and industrial imaging. In some contexts, a radiation detector can be bent or wrapped around an object to be imaged. Bending the radiation detector at too sharp of an angle can damage components of the radiation detector, which can render the radiation detector or portions thereof inoperable, reducing the longevity of the radiation detector.

### SUMMARY

An aspect of the present disclosure relates to a radiation detector including an imaging array configured to detect incident radiation in an active area and a bend restrictor coupled to the imaging array. The bend restrictor can at least partially overlap the active area.

In one or all examples, the bend restrictor can extend past a first edge of the imaging array and a second edge of the imaging array opposite the first edge in a direction perpendicular to the first and second edges. In one or all examples, the bend restrictor can include a plurality of clips configured to retain the imaging array in a first direction and allow the imaging array to translate in a second direction perpendicular to the first direction.

In one or all examples, the bend restrictor can include a plurality of links. Each of the links can include a first surface configured to restrict bending of the imaging array in a concave direction and a second surface configured to restrict bending of the imaging array in a convex direction.

In one or all examples, the radiation detector can further include an electronics housing including an electronics board coupled to the imaging array. The imaging array can be fixed relative to the electronics housing. The radiation detector can further include a handle housing coupled to the imaging array opposite the electronics housing. The imaging array can be configured to translate relative to the handle housing. In one or all examples, the radiation detector can further include a seal surrounding the imaging array. The seal can include a fixed seal coupled to the electronics housing and a sliding seal coupled to the handle housing.

In one or all examples, the bend restrictor can include a first plurality of outer links on a first side of the imaging array, a second plurality of outer links on a second side of the imaging array, and a plurality of inner links coupled to the first plurality of outer links and the second plurality of outer links. In one or all examples, the inner links have a length equal to or greater than a width of the imaging array between the first side and the second side. In one or all examples, the bend restrictor can further include a plurality of pins configured to couple the outer links to one another. Each of the pins can include a first protrusion configured to extend into a first outer link, a second protrusion configured to extend into a second outer link adjacent the first outer link, and an opening configured to receive a fastener for securing the pin to the first outer link or the second outer link.

Another aspect of the present disclosure relates to a radiation detector including a sensor stack, a bend restrictor adjacent to the sensor stack, and a seal surrounding the sensor stack and the bend restrictor.

In one or all examples, the bend restrictor can include a plurality of links disposed outside of an active area of the sensor stack.

In one or all examples, the radiation detector can further include a support extending under the sensor stack and the bend restrictor. The bend restrictor can be rotatably coupled to the support.

In one or all examples, the bend restrictor can include a plurality of links. Each of the links can include a first surface configured to restrict bending of the sensor stack in a first direction and a second surface configured to restrict bending of the sensor stack in a second direction opposite the first direction. In one or all examples, the first surface and the second surface of each link can extend in directions oblique to a longitudinal axis of the respective link. In one or all examples, the bend restrictor can further include a plurality of pins configured to couple the links to one another. Each of the pins can include a first protrusion configured to extend into a first link, a second protrusion configured to extend into a second link adjacent the first link, and an opening configured to receive a fastener for securing the pin to the first link or the second link.

Yet another aspect of the present disclosure relates to a radiation detector including an electronics housing, a handle housing, a sensor array extending between the electronics housing and the handle housing, and a bend restrictor coupled to the electronics housing and the handle housing. The bend restrictor can at least partially overlap the sensor array.

In one or all examples, the radiation detector can further include a sleeve configured to surround the sensor array and seal the sensor array to the electronics housing and the handle housing. In one or all examples, the bend restrictor can be coupled to an exterior surface of the sleeve.

In one or all examples, the bend restrictor can overlap a portion of the sensor array outside of an active area of the sensor array. In one or all examples, the bend restrictor can include a living hinge with hard stops that provide bend restriction in a first direction and a second direction opposite the first direction.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A is a top-down view of a radiation detector.

FIG. 1B is a side view of the radiation detector of FIG. 1A.

FIG. 2 is a side view of components of the radiation detector of FIG. 1A.

FIG. 3 is an exploded view of components of the radiation detector of FIG. 1A.

FIG. 4A is a perspective view of a bend restrictor of the radiation detector of FIG. 1A.

FIG. 4B is a side view of a portion of the bend restrictor of FIG. 4A.

FIG. 4C is an exploded view of the bend restrictor of FIG. 4A.

FIG. 4D is a cross-sectional view of a portion of the bend restrictor of FIG. 4A in a neutral position.

FIG. 4E is a cross-sectional view of a portion of the bend restrictor of FIG. 4A in a bent position.

FIG. 4F is a perspective view of the bend restrictor of FIG. 4A in a bent position.

FIG. 5A is a cross-sectional view of an electronics housing and a detector stack of the radiation detector of FIG. 1A.

FIG. 5B is a cross-sectional view of a handle housing and a detector stack of the radiation detector of FIG. 1A.

FIG. 5C is a cross-sectional view of a detector stack of the radiation detector of FIG. 1A.

FIG. 5D is a top-down view of components of the radiation detector of FIG. 1A.

FIG. 6A is a top-down view of components of the radiation detector of FIG. 1A in a neutral and bent position.

FIG. 6B is a top-down view of a bend detector.

FIG. 6C is a top-down view of a bend detector.

FIG. 7 is a perspective view of fasteners for a bend restrictor.

FIG. 8A is a top-down view of a radiation detector.

FIG. 8B is a side view of the radiation detector of FIG. 8A.

FIG. 8C is a cross-sectional view of a portion of the radiation detector of FIG. 8A.

FIG. 9 is an exploded view of components of the radiation detector of FIG. 8A.

FIG. 10A is a side view of a portion of a bend restrictor of the radiation detector of FIG. 8A in a neutral position.

FIG. 10B is a side view of the portion of the bend restrictor of FIG. 10A in a concave bent position.

FIG. 10C is a side view of the portion of the bend restrictor of FIG. 10A in a convex bent position.

FIG. 11A is a perspective view of a portion of a bend restrictor in a neutral position.

FIG. 11B is a side view of a portion of the bend restrictor of FIG. 11A in a concave bent position.

FIG. 12A is a side view of a portion of a bend restrictor in a neutral position.

FIG. 12B is a side view of a portion of the bend restrictor of FIG. 12A in a concave bent position.

FIG. 12C is a perspective view of a portion of the bend restrictor of FIG. 12A in a concave bent position.

FIG. 13A is a top-down view of a radiation detector.

FIG. 13B is a side view of the radiation detector of FIG. 13A.

FIG. 14A is a side view of a portion of a bend restrictor of the radiation detector of FIG. 13A in a neutral position.

FIG. 14B is a side view of the portion of the bend restrictor of FIG. 14A in a concave bent position.

FIG. 14C is a side view of the portion of the bend restrictor of FIG. 14A in a convex bent position.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to radiation detectors that can be used to detect radiation, such as x-rays. Radiation detectors can be used for imaging in a variety of contexts, including medical imaging, diagnostics, radiotherapy, non-destructive testing, materials detection or analysis, security inspection, and the like. In some contexts, a radiation detector can be bent or wrapped around an object to be imaged. Bending the radiation detector at too sharp of an angle can damage components of the radiation detector, which can render the radiation detector or portions thereof inoperable, reducing the longevity of the radiation detector.

More specifically, the following disclosure relates to radiation detectors that include bend restrictors, which limit or control the bending of the radiation detectors. Including a bend restrictor in a radiation detector can allow the radiation detector to bend or flex within a prescribed range, while preventing the radiation detector from bending outside this range. This can prevent the radiation detector from bending at too sharp of an angle, and can prevent components of the radiation detector from being damaged by bending. This improves the durability and longevity of the radiation detector, while still allowing the radiation detector to be used in contexts in which the radiation detector is bend or wrapped around an object. Further, the bend restrictors of the present disclosure can include customized bend restrictions that can be tuned based on characteristics of a radiation detector or contexts in which the radiation detector is to be used, optimizing protection provided by a bend restrictor and the contexts in which the radiation detector can be used.

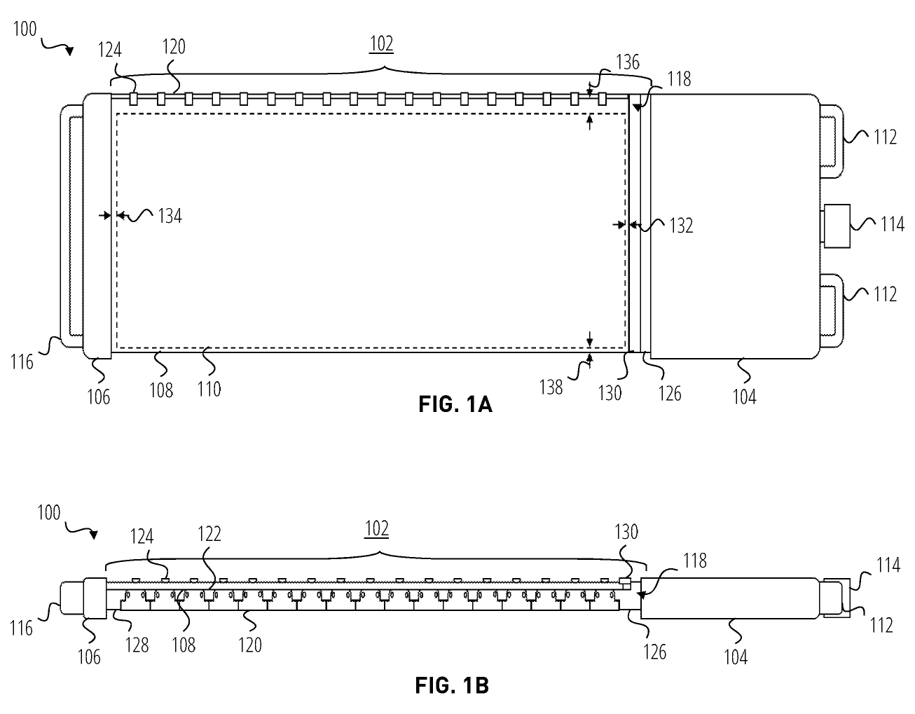

These and other examples are discussed below with reference to FIGS. 1A through 14C. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A and 1B illustrate a top-down and side view, respectively, of a radiation detector 100. As illustrated in FIGS. 1A and 1B, the radiation detector 100 can include a flexible section 102 extending between an electronics housing 104 and a handle housing 106. The flexible section 102 can include a detector stack 108 configured to detect radiation in an active area 110. The electronics housing 104 can house various electronics boards of the radiation detector 100, such as printed circuit boards (PCBs) and the like. The electronics housing 104 can also include one or more handles 112 and a connector 114. The connector 114 can be used to connect or couple the radiation detector 100 to external devices. Although the connector 114 is illustrated as being positioned between two handles 112 of the electronics housing 104 on a side surface of the electronics housing 104, the connector 114 can be positioned anywhere on the electronics housing 104, such as on a top surface, a bottom surface, or another side surface of the electronics housing 104. The handle housing 106 can include one or more handles 116. Then handles 112, 116 can be used to facilitate positioning the radiation detector 100 relative to an object to be imaged using a radiation source and the radiation detector 100.

The radiation detector 100 can be a flexible radiation detector, which can be wrapped around an object to be imaged. The radiation detector 100 can be used to image any objects, such as curved objects or the like. A non-exhaustive list of examples of objects the radiation detector 100 can be used to inspect can include pipes, windmills, radar domes, pressure vessels, concrete piers, human appendages, or any other objects. By including the flexible section 102, the radiation detector 100 can be wrapped around an object to be imaged.

However, bending the flexible section 102 to too great an extent can cause damage to components of the radiation detector 100 in the flexible section 102, thereby rendering the radiation detector 100 or portions thereof (e.g., pixels, lines, traces, or the like) inoperable, reducing the life of the radiation detector 100, reducing the cost-competitiveness of the radiation detector 100, and the like. For example, bending the flexible section 102 in a concave direction (e.g., towards a detection surface of the detector stack 108, towards a viewer of FIG. 1A, or upwards in FIG. 1B) can create compressive stress on pixels of the detector stack 108, which can damage the pixels of the detector stack 108. Bending the flexible section 102 in a convex direction (e.g., away from the detection surface of the detector stack 108, away from the viewer of FIG. 1A, or downwards in FIG. 1B) can create tensile stress on image sensor traces of the detector stack 108, which can cause discontinuities in the traces, dead pixels, dead lines, and the like. The detector stack 108 can withstand different degrees of bending in the concave direction and the convex direction without being damaged. For example, detector stack 108 can generally allow for a greater degree of bending in the concave direction relative to the convex direction.

In order to prevent damage to the detector stack 108, the radiation detector 100 can include a bend restrictor 118 in the flexible section 102. The bend restrictor 118 can limit the amount of bending that the detector stack 108 is allowed to experience in both the concave direction and the convex direction and can allow for different levels of bending in the concave direction and the convex direction. The limits of the bend restrictor 118 can depend on characteristics of the detector stack 108, applications for which the radiation detector 100 will be used, and the like. For example, components of the detector stack 108 can be damaged as a result to varying degrees of bending depending on characteristics of the detector stack 108 (e.g., detector type, detector fidelity, or the like). The radiation detector 100 can be used to image a variety of objects, which can have specific bending requirements (e.g., large diameter objects, small diameter objects, or the like).

The bend restrictor 118 can include outer links 120, inner links 122, clips 124, an electronics-side anchor 126, a handle-side anchor 128, and a retainer 130. Interference between surfaces of the inner links 122 and the adjacent outer links 120 can restrict bending of the flexible section 102 in the concave direction. For example, as the flexible section 102 bends in the concave direction, surfaces of the inner links 122 can contact surfaces of the adjacent outer links 120 to limit further bending in the concave direction. Interference between surfaces adjacent ones of the outer links 120 can restrict bending of the flexible section 102 in the convex direction. For example, as the flexible section 102 bends in the convex direction, surfaces of adjacent outer links 120 can contact one another to limit further bending in the convex direction. Various characteristics of the outer links 120 and the inner links 122 can be tailored to provide different bending limits in the concave direction and the convex direction. For example, angles of the surfaces of the outer links 120 and the inner links 122, distances between the surfaces of the outer links 120 and the inner links 122, attachment points between the outer links 120 and the inner links 122, and the like can be separately tailored to allow for desired ranges of bending in the concave direction and in the convex direction.

The electronics-side anchor 126 can be coupled to one of the outer links 120, each of the inner links 122 can be coupled to two of the outer links 120, and the handle-side anchor 128 can be coupled to one of the outer links 120. The outer links 120 can be coupled to the electronics-side anchor 126, the inner links 122, and the handle-side anchor 128 by any suitable fasteners, such as pins, screws, bolts, rods, or any other suitable fasteners. The fasteners used to couple the outer links 120 to the electronics-side anchor 126, the inner links 122, and the handle-side anchor 128 can allow the outer links 120 to rotate freely relative to the electronics-side anchor 126, the inner links 122, and the handle-side anchor 128.

In the example illustrated in FIGS. 1A and 1B, the bend restrictor 118 can have a width greater than a width of the detector stack 108. Providing the bend restrictor 118 with a width equal to or greater than a width of the detector stack 108 can increase a torsional stiffness of the bend restrictor 118, preventing bending of the flexible section 102 in directions other than the concave direction and the convex direction. For example, the bend restrictor 118 can prevent twisting of the flexible section 102 in a direction parallel to a longitudinal axis of the flexible section 102. The bend restrictor 118 can include a first set of outer links 120 (illustrated in FIG. 1A) on a first side of the detector stack 108 and a second set of outer links 120 (illustrated in FIG. 1B) under the detector stack 108. In one or all examples, the second set of outer links 120 can be disposed on a second side of the detector stack 108 opposite the first side. The inner links 122 can have lengths equal to or greater than a width of the detector stack 108. The detector stack 108 can overlap the inner links 122 and at least partially overlap the first set of outer links 120 and/or the second set of outer links 120. The configuration of the first set of outer links 120, the inner links 122, and the second set of outer links 120 can be used to decrease the overall size, weight, and cost of the radiation detector 100, while providing desired levels of torsional stiffness to the flexible section 102.

The clips 124 can be used to secure the detector stack 108 to the bend restrictor 118. The clips 124 can be part of the outer links 120 on the first side of the detector stack 108, or can be coupled to the outer links 120. The clips 124 can secure the detector stack 108 to the bend restrictor 118 in certain directions, while allowing the detector stack 108 to move relative to the bend restrictor 118 in other directions. For example, when the flexible section 102 bends in a concave direction or a convex direction, a length of the detector stack 108 relative to the bend restrictor 118 can increase. The clip 124 can allow the detector stack 108 to translate relative to the bend restrictor 118 to accommodate this length difference. In other words, the clips 124 can secure the detector stack 108 to the bend restrictor 118 in a direction perpendicular to the page of FIG. 1A, a vertical direction of FIG. 1B, and a direction perpendicular to a major surface of the detector stack 108, while allowing the detector stack 108 to translate relative to the bend restrictor 118 in a side-to-side direction of FIG. 1A, a side-to-side direction of FIG. 1B, and a direction parallel to longitudinal axes of the flexible section 102, the detector stack 108, and the bend restrictor 118.

The electronics housing 104 and/or the handle housing 106 can further be configured to accommodate the difference in length between the bend restrictor 118 and the detector stack 108 as the flexible section 102 bends. For example, the detector stack 108 can be fixed to the electronics housing 104. The handle housing 106 can include an opening or recess into which the detector stack 108 can move or slide as the flexible section 102 bends in the concave direction or the convex direction. A fixes seal can be formed between the detector stack 108 and the electronics housing 104. A sliding seal can be formed between the detector stack 108 and the handle housing 106 so that the detector stack 108 remains sealed, even as the detector stack 108 translates into and out of the handle housing 106.

The electronics-side anchor 126 and the handle-side anchor 128 can secure the bend restrictor 118 to the electronics housing 104 and the handle housing 106, respectively. The electronics-side anchor 126 and/or the handle-side anchor 128 can include surfaces that interface with surfaces of the outer links 120 to provide bend limits on the flexible section 102 similar to the bend limits provided by the outer links 120 and the inner links 122. The detector stack 108 can be coupled to the bend restrictor 118 through the electronics-side anchor 126 and the retainer 130 or can be coupled directly to the electronics housing 104. Fasteners can be provided through the retainer 130, the detector stack 108, and/or the electronics-side anchor 126 to couple the detector stack 108 to the bend restrictor 118.

FIG. 1A further illustrates various dimensions of the radiation detector 100. A sensor array of the detector stack 108 can have a width in a range from about 2 inches to about 6 inches, from about 3.2 inches to about 4.8 inches, from about 3.6 inches to about 4.4 inches, about 3.8 inches, about 4 inches, or the like. The sensor array can have a length in a range from about 6 inches to about 14 inches, from about 8 inches to about 12 inches, from about 9 inches to about 11 inches, about 10 inches, about 10.08 inches, or the like. The sensor array can include a plurality of pixels, which can be square and have dimensions of about 100 μm, in a range from about 80 μm to about 120 μm, from about 90 μm to about 110 μm, or the like. The sensor array can include any number of pixels. For example, the sensor array can include about 2560 rows and about 966 or about 1024 columns of pixels; however, any suitable number of rows and columns of pixels can be included in the pixel array of the sensor array. The active area 110 of the detector stack 108 can have a width in a range from about 2 inches to about 6 inches, from about 3.2 inches to about 4.8 inches, from about 3.6 inches to about 4.4 inches, about 3.8 inches, about 4 inches, or the like. The active area 110 of the detector stack 108 can have a length in a range from about 6 inches to about 14 inches, from about 8 inches to about 12 inches, from about 9 inches to about 11 inches, about 10 inches, about 10.08 inches, or the like. The flexible section 102 can have a width in a range from about 2.2 inches to about 6.6 inches, from about 3.4 inches to about 5.2 inches, from about 3.85 inches to about 4.75 inches, about 4.37 inches, about 4.2 inches, or the like. The flexible section 102 can have a length in a range from about 6.4 inches to about 14.6 inches, from about 8.3 inches to about 12.6 inches, from about 9.4 inches to about 11.5 inches, about 10.5 inches, about 10.65 inches, or the like. A distance 132 from the active area 110 to an edge of the flexible section 102 proximal the electronics housing 104 (e.g. , between the active area 110 and the retainer 130) can be in a range from about 8 mm to about 12 mm, from about 8.5 mm to about 11.7 mm, about 8.6 mm, about 11.6 mm, or the like. A distance 134 from the active area 110 to an edge of the flexible section 102 distal the electronics housing 104 (e.g., between the active area 110 and the handle housing 106) can be in a range from about 2.4 mm to about 3.6 mm, from about 2.7 mm to about 3.3 mm, about 3 mm, or the like. A distance 136 from the active area 110 to an edge of the flexible section 102 on a clip 124 edge of the bend restrictor 118 can be in a range from about 6.5 mm to about 10 mm, from about 7.5 mm to about 9.2 mm, about 7.8 mm, about 8.85 mm, or the like. A distance 138 from the active area 110 to an edge of the flexible section 102 opposite the clip 124 edge of the bend restrictor 118 can be in a range from about 0.7 mm to about 1.5 mm, from about 0.8 mm to about 1.3 mm, about 0.8 mm, about 1.3 mm, or the like. The flexible section 102 can have a thickness in a range from about 0.4 inches to about 0.6 inches, in a range from about 0.45 inches to about 0.55 inches, about 0.5 inches, or the like. A ratio of a length of the active area 110 to a length of the flexible section 102 can be greater than about 0.75, greater than about 0.85, greater than about 0.9, greater than about 0.95, or about 0.95. A ratio of a width of the active area 110 to a width of the flexible section 102 can be greater than about 0.7, greater than about 0.8, greater than about 0.85, greater than about 0.9, or about 0.9.

By providing radiation detectors including bend restrictors disclosed herein, a thickness of the flexible section 102 can be minimized and the active area 110 relative to the area of the flexible section 102 can be maximized in order to provide compact radiation detectors. This allows for the radiation detectors to be used in tight spaces and improves the usability of the radiation detectors.

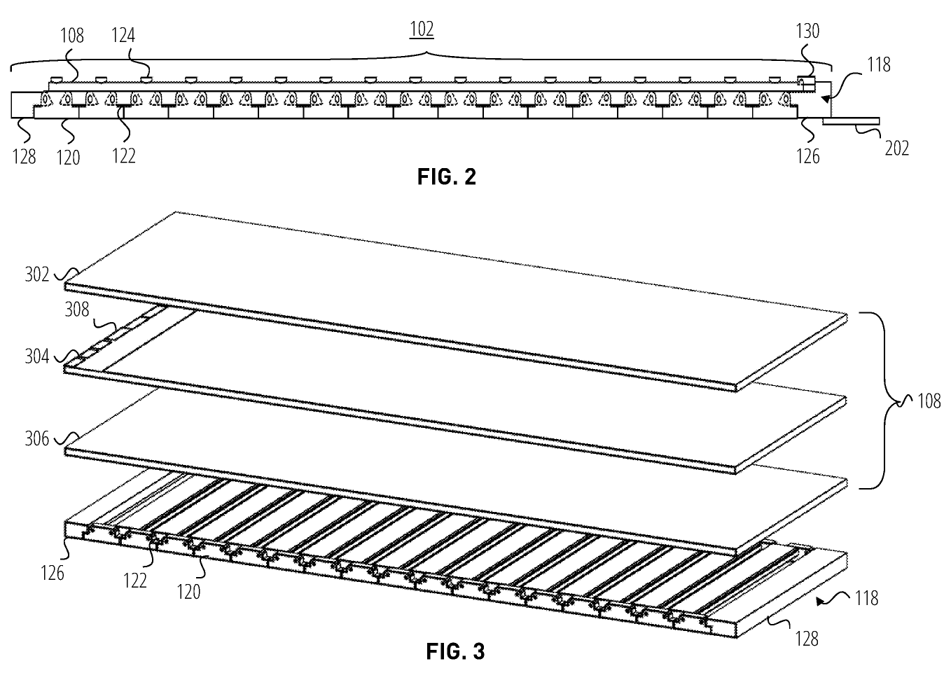

FIG. 2 illustrates a side view of components of the radiation detector 100. Specifically, FIG. 2 illustrates the flexible section 102 (including the detector stack 108 and the bend restrictor 118) and an electronics board 202 of the radiation detector 100. The bend restrictor 118 can include outer links 120, inner links 122, clips 124, an electronics-side anchor 126, a handle-side anchor 128, and a retainer 130. The detector stack 108 can be physically connected or coupled to the electronics-side anchor 126 and the retainer 130, between the electronics-side anchor 126 and the retainer 130. The clips 124 can retain or secure the detector stack 108 relative to the bend restrictor 118, while allowing the detector stack 108 to translate as the flexible section 102 bends. The electronics board 202 can be electrically coupled to the detector stack 108 through the electronics-side anchor 126. For example, connectors (e.g., wires, ribbon connectors, other flexible connectors, or the like) can extend through the electronics-side anchor 126 to electrically couple the detector stack 108 to the electronics board 202.

The electronics board 202 can be disposed in the electronics housing 104 (not separately illustrated in FIG. 2). The electronics board 202 can be configured to control the detector stack 108, processing of image data from the detector stack 108, transmission of that data from the radiation detector 100 (e.g., through the connector 114), and other operations of the radiation detector 100. The electronics board 202 can include control logic for the radiation detector 100. The electronics board 202 can include one or more general-purpose processors, digital signal processors (DSPs), application specific integrated circuits (ASICs), microcontrollers, programmable logic devices (e.g., field programmable gate arrays (FPGAs) or the like), discrete circuits, or the like. In addition, other interface devices, such as circuit chipsets, hubs, memory control logics, communication interfaces, or the like may be part of or coupled with the electronics board 202 to connect the electronics board 202 to internal and external components of the radiation detector 100. The electronics board 202 can include active components or circuits, such as integrated circuit (IC) chips, which can include ASICs, FPGAs, system-on-chips (SoCs), readout circuits, amplifiers, analog to digital converters, processors, or the like. In one or all examples, the electronics board 202 can include an ASIC, a processor, and a programmable logic device, which can each be coupled to a memory. The active components can be configured to perform various operations on data received from the detector stack 108, configured to control the detector stack 108, configured to control other functions of the radiation detector 100, or the like

The detector stack 108 can be sealed to protect components of the detector stack 108 from an external environment of the radiation detector 100. For example, a sleeve or cover can surround at least a portion of the detector stack 108. The sleeve can be formed from materials such as silicone, rubbers, polymers, elastomers, or the like. The sleeve can be sealed to the electronics housing 104, the handle housing 106, and/or portions of the bend restrictor 118. In the example of FIG. 2, the sleeve of the detector stack 108 is sealed to the bend restrictor 118 between the retainer 130 and the electronics-side anchor 126. This can allow for electrical connections to pass from the detector stack 108 through the bend restrictor 118 to the electronics housing 104. In one or all examples, the detector stack 108 can be sealed within the sleeve and an exterior surface of the sleeve can be coupled to the bend restrictor 118. The retainer 130 and/or the electronics-side anchor 126 can include recesses and the sleeve of the detector stack 108 can include protrusions having shapes corresponding to the recesses that extend into the recesses of the retainer 130 and/or the electronics-side anchor 126 in order to seal the sleeve of the detector stack 108 to the retainer 130 and/or the electronics-side anchor 126. As such, the detector stack 108 can be sealed from an external environment and components thereof can be protected from damage by water, contaminants, and the like.

FIG. 3 illustrates an exploded view of a stack-up for the detector stack 108 and the bend restrictor 118. As illustrated in FIG. 3, the detector stack 108 can include a front support plate 302, a sensor array 304, and a rear support plate 306. Although not separately illustrated in FIG. 3, the front support plate 302, the sensor array 304, and the rear support plate 306 can be wrapped in a sleeve or cover, which can be formed from silicone, rubbers, polymers, elastomers, plastics, or the like. In one or all examples, the bend restrictor 118 can also be wrapped in the sleeve. The sleeve can protect components of the detector stack 108 from exposure to contaminants such as water, dust, other chemicals, or the like, which can damage components of the detector stack 108.

The sensor array 304 can be configured to generate an image in response to incident radiation. The sensor array 304 can define an active area of the detector stack 108 (e.g., the active area 110), which can at least partially overlap the bend restrictor 118. The sensor array 304 can include a variety of sensors configured to generate data based on incident radiation. The sensor array 304 can include direct conversion sensors, indirect conversion sensors, photon counters, radiation conversion materials (e.g., scintillator materials), or the like. The sensor array 304 can include connectors 308, which can be used to couple the sensor array 304 to other components of a radiation detector, such as electronics boards and the like.

The front support plate 302 and the rear support plate 306 can be used to support the sensor array 304. The front support plate 302 can be formed a material having a low coefficient of friction and a high transparency to radiation. The front support plate 302 can prevent friction on an outward-facing surface of the sensor array 304. In one or all examples, the front support plate 302 can be formed from ultra-high-molecular-weight (UHMW) materials, such as polyethylene or the like. The rear support plate 306 can be formed from one or more layers of materials. The rear support plate 306 can be formed from materials having low transparency to radiation in order to prevent backscatter after radiation has passed through the sensor array 304. The rear support plate 306 can also be formed from materials having a low coefficient of friction and can prevent friction on a rear-facing surface of the sensor array 304. The rear support plate 306 can include a tungsten rubber material, a UHMW material, such as polyethylene, layers thereof, or the like.

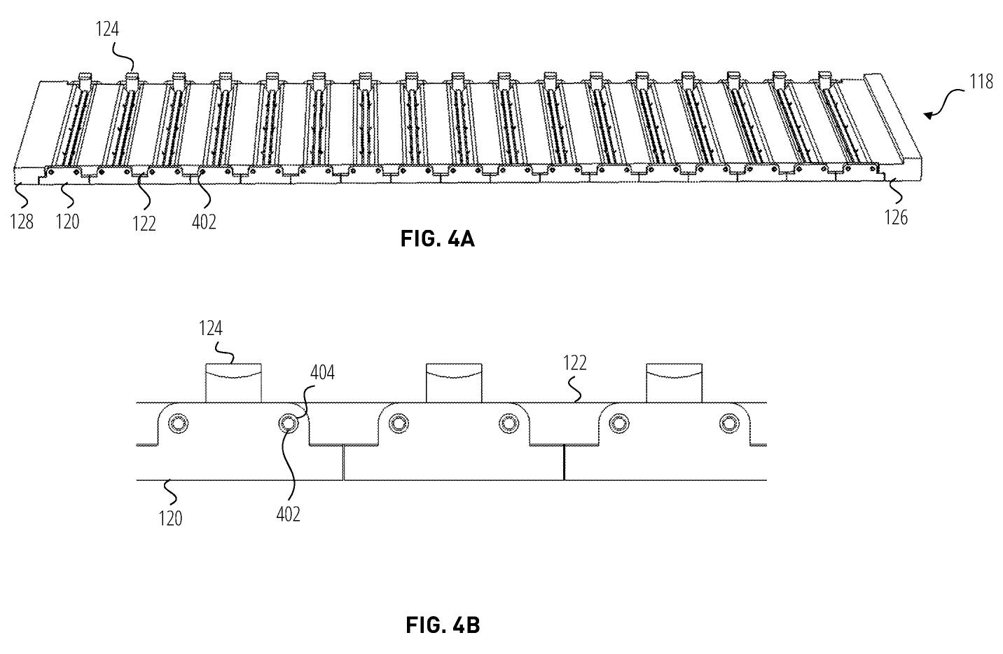

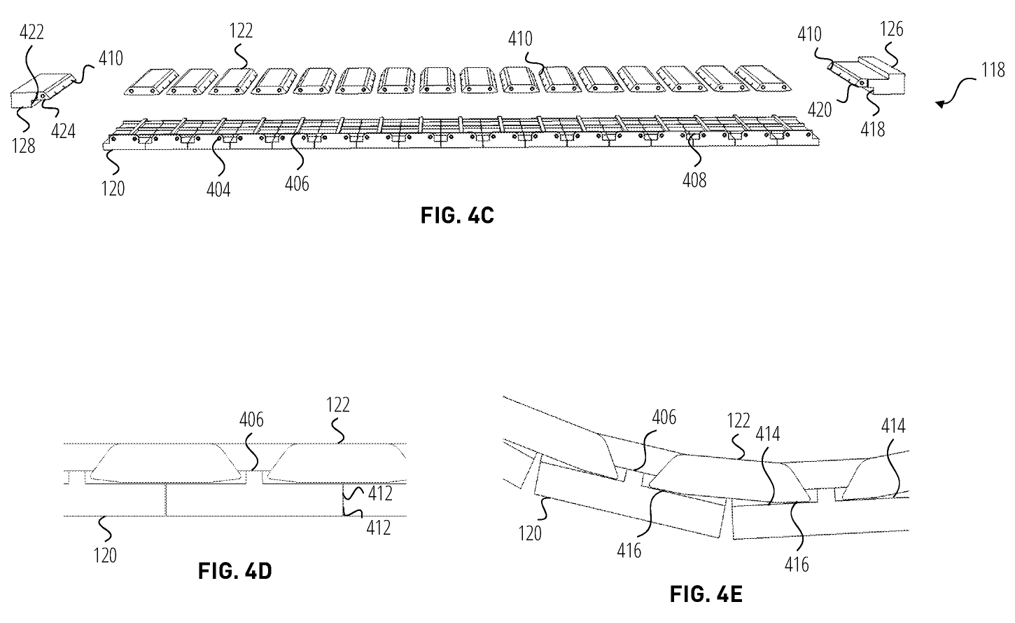

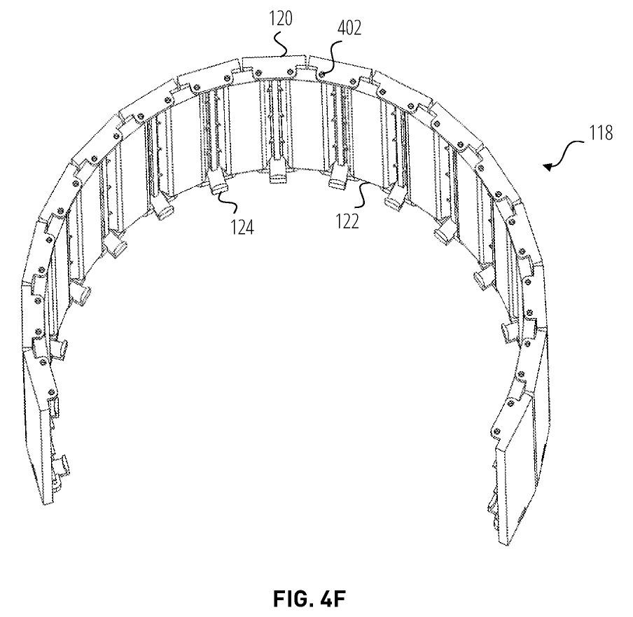

FIGS. 4A through 4F show various views of the bend restrictor 118. FIGS. 4A through 4F illustrate how the bend restrictor 118 limits bending of the flexible section 102 in the concave direction and the convex direction. FIG. 4A illustrates a perspective view of the bend restrictor 118. FIG. 4B illustrates a side view of a portion of the bend restrictor 118. FIGS. 4A and 4B illustrate the bend restrictor 118 in a neutral bending configuration. FIG. 4C illustrates an exploded view of the bend restrictor 118. FIG. 4D illustrates a cross-sectional view of a portion of the bend restrictor 118 when the bend restrictor 118 is bent in a convex direction. FIG. 4E illustrates a cross-sectional view of a portion of the bend restrictor 118 when the bend restrictor 118 is bent in a concave direction. FIG. 4F illustrates a perspective view of the bend restrictor 118 bent in the concave direction.

The bend restrictor 118 can include a handle-side anchor 128, outer links 120, inner links 122, clips 124, and an electronics-side anchor 126. The handle-side anchor 128 can be coupled to an adjacent outer link 120 by a fastener 402. Each of the inner links 122 can be coupled to two adjacent outer links 120 by fasteners 402. The electronics-side anchor 126 can be coupled to an adjacent outer link 120 by a fastener 402.

The fasteners 402 can include any suitable fasteners that allow the outer links 120 to rotate relative to the handle-side anchor 128, the inner links 122, and the electronics-side anchor 126. For example, the fasteners 402 can include pins, screws, bolts, rods, or any other suitable fasteners. In the example illustrated in FIGS. 4A through 4F, the fasteners 402 can be internal fasteners that extend from one end of a respective outer link 120, through a handle-side anchor 128, inner link 122, or electronics-side anchor 126, to an opposite end of the respective outer link 120.

In one or all examples, the fasteners 402 can include threads, which can be threadedly coupled to the outer links 120. In one or all examples, the fasteners 402 can include protrusions that extend into the outer links 120 and springs, which can allow the fasteners 402 to be inserted between opposite ends of the outer links 120. In one or all examples, an interference fit between the fasteners 402 and the outer links 120 can be used to retain the fasteners 402 relative to the bend restrictor 118.

The clips 124 can be formed as part of the outer links 120, or can be coupled to the outer links 120. The clips 124 can be coupled to the outer links 120 by any suitable means, such as brazing, fasteners, clips, glues, threads, welding, soldering, or the like. Although a single clip 124 is illustrated as being provided on one end of each of the outer links 120, in one or all examples, each of the outer links 120 can be provided with two clips 124 at opposite ends of the outer links 120. Providing a single clip 124 for each of the outer links 120 can reduce an area of the bend restrictor 118, and can reduce any area of a detector stack 108 that will be covered by the bend restrictor 118. This can reduce the size of a radiation detector 100. Providing two clips 124 for each of the outer links 120 can more securely couple a detector stack 108 to the bend restrictor 118.

As illustrated in FIG. 4C, the outer links 120 can include first ribs 406 and second ribs 408. The first ribs 406 and the second ribs 408 can add additional stiffness to the bend restrictor 118, maintain relative positions of the outer links 120 and each of the handle-side anchor 128, the inner links 122, and the electronics-side anchor 126, control movement between the outer links 120 and each of the handle-side anchor 128, the inner links 122, and the electronics-side anchor 126, and aid in positioning the components of the bend restrictor 118 relative to one another during assembly of the bend restrictor 118.

The first ribs 406 can extend in directions parallel to longitudinal axes of the outer links 120 (e.g., perpendicular to a longitudinal axis of the bend restrictor 118). Each of the outer links 120 can include a first rib 406, which can be positioned between adjacent inner links 122, between an adjacent inner link 122 and the adjacent handle-side anchor 128, or between an adjacent inner link 122 and the adjacent electronics-side anchor 126.

The second ribs 408 can extend in directions perpendicular to the longitudinal axes of the outer links 120 (e.g., parallel to the longitudinal axis of the bend restrictor 118). Each of the outer links 120 can include a multiple second ribs 408. The handle-side anchor 128, the inner links 122, and the electronics-side anchor 126 can include openings 410 corresponding to the second ribs 408, and the second ribs 408 can extend into the openings 410. Relative sizes of the second ribs 408 and the openings 410 can be used to provide different degrees of stiffness to the bend restrictor 118. For example, providing relatively large openings 410 for the second ribs 408 can decrease the stiffness of the bend restrictor 118, while providing relatively small openings 410 for the second ribs 408 can increase the stiffness of the bend restrictor 118.

As illustrated in FIG. 4D, the outer links 120 can include outer surfaces 412. The outer surfaces 412 of adjacent outer links 120 can contact one another when the bend restrictor 118 is bent in a convex direction in order to prevent further bending of the bend restrictor 118 in the convex direction. Depending on relative angles between the outer surfaces 412 of adjacent outer links 120 and the distance between the outer surfaces 412 of the adjacent outer links 120, the bend restrictor 118 can allow for different levels of bending in the convex direction. For example, angling the outer surfaces 412 such that bottom edges of the outer surface 412 are further apart from one another can accommodate greater degrees of bending, while angling the outer surfaces 412 such that bottom edges of the outer surface 412 are closer together can accommodate lesser degrees of bending. Similarly, spacing the outer surfaces 412 further apart can accommodate greater degrees of bending, while spacing the outer surfaces 412 closer together can accommodate lesser degrees of bending.

As illustrated in FIG. 4E, the outer links 120 can include upper surfaces 414 that face toward the inner links 122 and the inner links 122 can include lower surfaces 416 that face toward the outer links 120. Upper surfaces 414 of the outer links 120 can contact lower surfaces 416 of adjacent inner links 122 when the bend restrictor 118 is bent in a concave direction in order to prevent further bending of the bend restrictor 118 in the concave direction. Depending on relative angles between the upper surfaces 414 and the lower surfaces 416 of adjacent outer links 120 and inner links 122, attachment points of the inner links 122 relative to the outer links 120, and distances between the upper surfaces 414 and the lower surfaces 416, the bend restrictor 118 can allow for different levels of bending in the concave direction. For example, angling the upper surfaces 414 and the lower surfaces 416 such that outer edges of the lower surfaces 416 are vertically further apart from the upper surfaces 414 can accommodate greater degrees of bending, while angling the upper surfaces 414 and the lower surfaces 416 such that outer edges of the lower surfaces 416 are vertically closer to the upper surfaces 414 can accommodate lesser degrees of bending. Spacing the upper surfaces 414 and the lower surfaces 416 further apart can accommodate greater degrees of bending, while spacing the upper surfaces 414 and the lower surfaces 416 closer together can accommodate lesser degrees of bending. Coupling the inner links 122 higher relative to the outer links 120 can accommodate greater degrees of bending, while coupling the inner links 122 lower relative to the outer links 120 can accommodate lesser degrees of bending.

The electronics-side anchor 126 and the handle-side anchor 128 can function similarly to the outer links 120 and the inner links 122 to provide bend limits in the bend restrictor 118. For example, the electronics-side anchor 126 can include an outer surface 418 that can contact an outer surface 412 of an adjacent outer link 120 to limit bending of the bend restrictor 118 in the convex direction. The electronics-side anchor 126 can include a lower surface 420 that can contact an upper surface 414 of the adjacent outer link 120 to limit bending of the bend restrictor 118 in the concave direction. The handle-side anchor 128 can include an outer surface 422 that can contact an outer surface 412 of an adjacent outer link 120 to limit bending of the bend restrictor 118 in the convex direction. The handle-side anchor 128 can include a lower surface 424 that can contact an upper surface 414 of the adjacent outer link 120 to limit bending of the bend restrictor 118 in the concave direction.

FIG. 4F illustrates the bend restrictor 118 in a concave bent configuration. Bending the bend restrictor 118 in either the concave direction or the convex direction can reduce an effective length of the bend restrictor 118 as the spacing between the outer links 120 and the inner links 122, the electronics-side anchor 126, and the handle-side anchor 128 becomes smaller. As a result, the clips 124 can retain a detector stack 108 (not separately illustrated) in a manner that allows the detector stack 108 to translate relative to the bend restrictor 118.

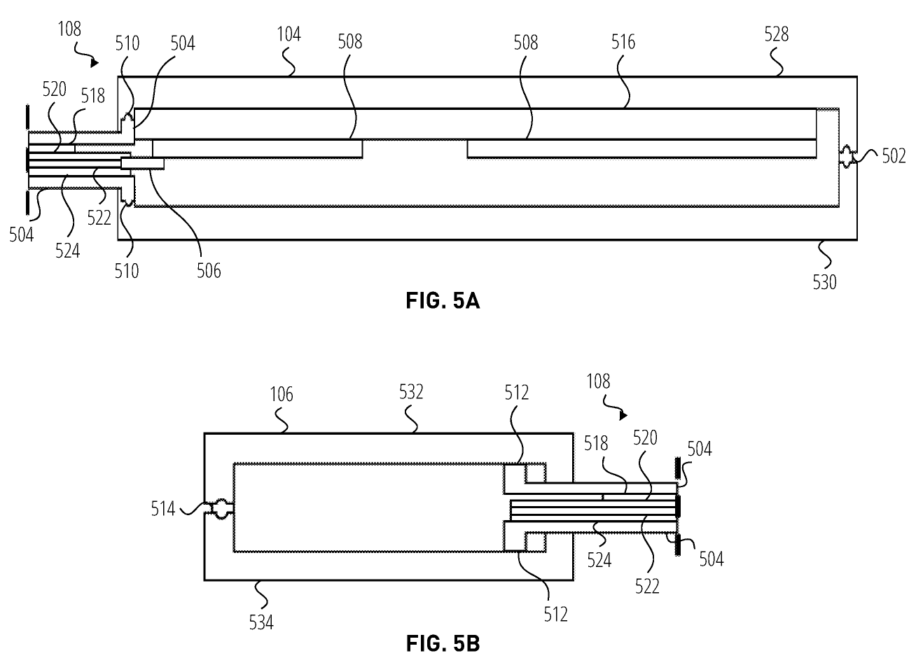

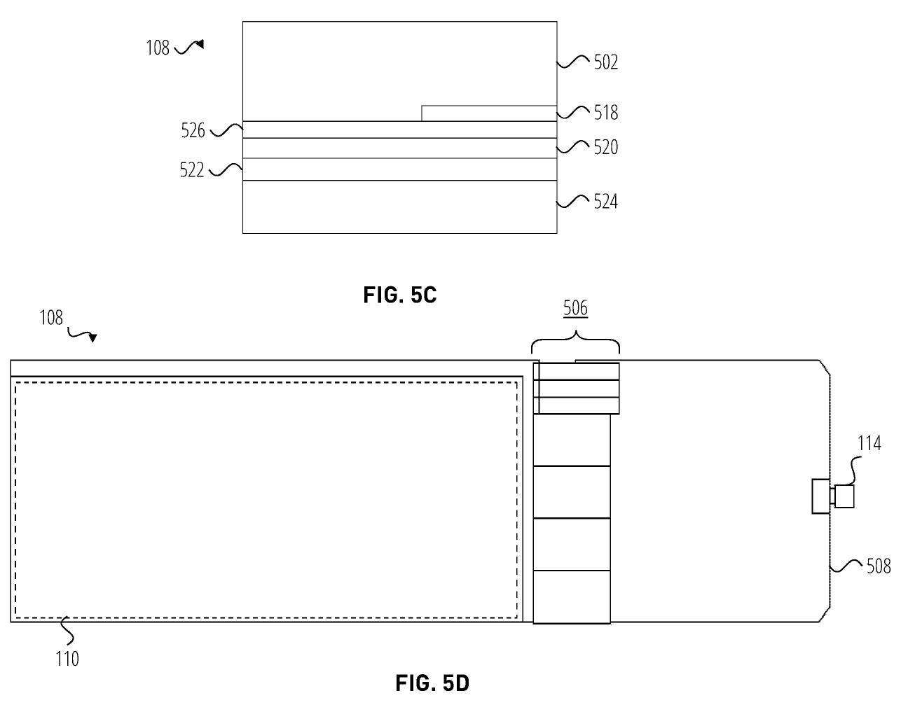

FIGS. 5A through 5D illustrate various electronic components of the radiation detector 100. FIG. 5A illustrates a cross-sectional view of an interface between the detector stack 108 and the electronics housing 104. FIG. 5B illustrates a cross-sectional view of an interface between the detector stack 108 and the handle housing 106. FIG. 5C illustrates a cross-sectional view of the detector stack 108. FIG. 5D illustrates a top-down view of portions of the detector stack 108 and the electronics housing 104.

FIG. 5A illustrates electrical and mechanical connections between the detector stack 108 and the electronics housing 104. The electronics housing 104 can define an enclosure, which can house various components of a radiation detector. The electronics housing 104 can include an upper housing portion 528 and a lower housing portion 530, which can be coupled to one another by a seal 502. The upper housing portion 528 and the lower housing portion 530 can be formed from metals (e.g., steel, aluminum, or the like), polymers, plastics, or the like. The seal 502 can be a molded sealing O-ring or the like, which can be formed from polymers, plastics, rubbers, or the like. The upper housing portion 528 can be coupled to the seal 502 and/or the lower housing portion 530 by any suitable means, such as adhesives, brazing, fasteners, clips, or the like.

FIG. 5B illustrates electrical and mechanical connections between the detector stack 108 and the handle housing 106. The handle housing 106 can define an enclosure, which can house at least a portion of the detector stack 108. As discussed throughout the present disclosure, as a flexible section of a radiation detector bends, the detector stack 108 can move or slide relative to a bend restrictor of the radiation detector. Distances between links of the bend restrictor can decrease, decreasing a length of the bend restrictor. A length of the detector stack 108 can remain substantially constant, such that the length of the detector stack 108 relative to the bend restrictor increases. The enclosure of the handle housing 106 can be configured to receive a portion of the detector stack 108 to accommodate this relative length increase of the detector stack 108. As the flexible section of the radiation detector bends, a portion of the detector stack 108 can extend into the enclosure of the handle housing 106, and the detector stack 108 can be withdrawn from the handle housing 106 as the flexible section moves back to a flat or neutral position.

The handle housing 106 can include an upper housing portion 532 and a lower housing portion 534, which can be coupled to one another by a seal 514. The upper housing portion 532 and the lower housing portion 534 can be formed from metals (e.g., steel, aluminum, or the like), polymers, plastics, or the like. The seal 514 can be a molded sealing o-ring or the like, which can be formed from polymers, plastics, rubbers, or the like. The upper housing portion 532 can be coupled to the seal 514 and/or the lower housing portion 534 by any suitable means, such as adhesives, brazing, fasteners, clips, or the like.

The detector stack 108 can include a sleeve 504 that surrounds components of the detector stack 108. The sleeve 504 can seal the components of the detector stack 108, preventing contaminants such as water, dust, chemicals, and the like from damaging the components of the detector stack 108. The sleeve 504 can be formed from materials such as rubbers, polymers, elastomers, plastics, or the like, which can prevent contaminants from penetrating through the sleeve 504 and damaging components of the detector stack 108.

The sleeve 504 can form a fixed seal 510 with the electronics housing 104 and a sliding seal 512 with the handle housing 106. For example, as illustrated in FIG. 5A, the sleeve 504 can form fixed seals 510 between the sleeve 504 and the upper housing portion 528 and between the sleeve 504 and the lower housing portion 530. The sleeve 504 can include protrusions that extend into recesses defined in the upper housing portion 528 and lower housing portion 530 of the electronics housing 104 to form the fixed seals 510. In one or all examples, the upper housing portion 528 and/or the lower housing portion 530 can include protrusions that extend into recesses defined in the sleeve 504. The upper housing portion 528 and the lower housing portion 530 can be coupled to the sleeve 504 to form the fixed seals 510 by any suitable means, such as adhesives, fasteners, clips, or the like.

As illustrated in FIG. 5B, the sleeve 504 can form sliding seals 512 between the sleeve 504 and the upper housing portion 532 and between the sleeve 504 and the lower housing portion 534. The sliding seals 512 can allow end portions of the detector stack 108 disposed in the handle housing 106 to remain sealed, even as the detector stack 108 moves into and out of the handle housing 106. In one or all examples, the sleeve 504 can extend around end surfaces of the other components of the detector stack 108 in the handle housing 106 to seal the detector stack 108. The sliding seals 512 can be formed by interference between the sleeve 504 and each of the upper housing portion 532 and the lower housing portion 534.

The detector stack 108 can include a scintillator 518, a sensor 520, a baseplate 522, and a rear support plate 524. The detector stack 108 can be arranged with the scintillator 518 facing a radiation source, the sensor 520 disposed on a backside of the scintillator 518, the baseplate 522 on a backside of the sensor 520, and the rear support plate 524 on a backside of the baseplate 522. The sleeve 504 can surround a top, bottom, and side surfaces of the other components of the detector stack 108.

The scintillator 518 can include a material that emits light or fluoresces when exposed to radiation, such as x-rays. The sensor 520 can include direct conversion sensors, indirect conversion sensors, photon counters, radiation conversion materials (e.g., scintillator materials), or the like. The scintillator 518 can be coupled to the sensor 520 by an adhesive 526, which can be an optically clear adhesive. The baseplate 522 can be provided to increase a stiffness or rigidity of the detector stack 108. The baseplate 522 can be formed from materials having a desired level of stiffness, flexibility, and elasticity, while having a minimal density. For example, the baseplate 522 can be formed from metals, such as aluminum or steel; carbon fiber; plastic materials; polymer materials; fiberglass; an epoxy resin; or the like. The baseplate 522 can be formed from materials having a low coefficient of friction and can prevent friction on a rear-facing surface of the sensor 520. The rear support plate 524 can be formed from materials having low transparency to radiation in order to prevent backscatter after radiation has passed through overlying layers of the detector stack 108. The rear support plate 524 can include a tungsten rubber material, a UHMW material, such as polyethylene, layers thereof, or the like.

As illustrated in FIG. 5C, components of the detector stack 108 can have different widths. For example, the scintillator 518 and/or the sensor 520 can have an area equal to an active area of the detector stack 108. However, each of the components of the detector stack 108 can have any suitable width and area.

An electronics board 508 of the radiation detector can be positioned within the electronics housing 104. The electronics board 508 can be electrically coupled to the sensor 520 of the detector stack 108 through a connector 506. The connector 506 can be electrically coupled to the sensor 520 and the electronics board 508 and can extend between the detector stack 108 and the electronics housing 104. In one or all examples, the connector 506 can extend through components of a bend restrictor, such as a retainer, an electronics-side anchor, or the like. The connectors 506 can include any suitable connectors, such as board-to-board (BTB) connectors, wires, ribbon cables, or any other flexible or rigid connectors.

The electronics board 508 is configured to control the detector stack 108 (e.g., the sensor 520), processing of image data from the detector stack 108, transmission of that data from the radiation detector, and other operations of the radiation detector. The electronics board 508 can include control logic for the radiation detector. The electronics board 508 can include a general-purpose processor, a digital signal processor (DSP), an application specific integrated circuit (ASIC), a microcontroller, a programmable logic device (e.g., a field programmable gate array (FPGA) or the like), discrete circuits, a combination of such devices, or the like. In addition, other interface devices, such as circuit chipsets, hubs, memory control logics, communication interfaces, or the like may be part of or coupled with the electronics board 508 to connect the electronics board 508 to internal and external components of the radiation detector. The connector 114 can be used to connect the electronics board 508 to external devices. The electronics board 508 can include active components or circuits, such as integrated circuit (IC) chips, which can include ASICs, FPGAs, system-on-chips (SoCs), readout circuits, amplifiers, analog to digital converters, processors, or the like. In one or all examples, the electronics board 508 can include an ASIC, a processor, and a programmable logic device, which can each be coupled to a memory. The active components can be configured to perform various operations on data received from the detector stack 108, configured to control the detector stack 108, configured to control other functions of the radiation detector, or the like. The electronics board 508 can be configured as one or more electronics boards on one or more substrates. For example, in FIG. 5A, two electronics boards 508 are illustrated, while in FIG. 5B, a single electronics board 508 is illustrated.

The electronics housing 104 can include a shield 516. The shield 516 can shield the electronics board 508 from incident radiation and protect components of the electronics board 508. The shield 516 can be formed from can be formed from metals (e.g., steel, tungsten, lead, or the like), polymers, plastics, or the like. In one or all examples, the shield 516 can be integrated into the upper housing portion 528. In one or all examples, the upper housing portion 528 can be formed from materials and with dimensions sufficient to shield the electronics board 508 from incident radiation and the shield 516 can be omitted.

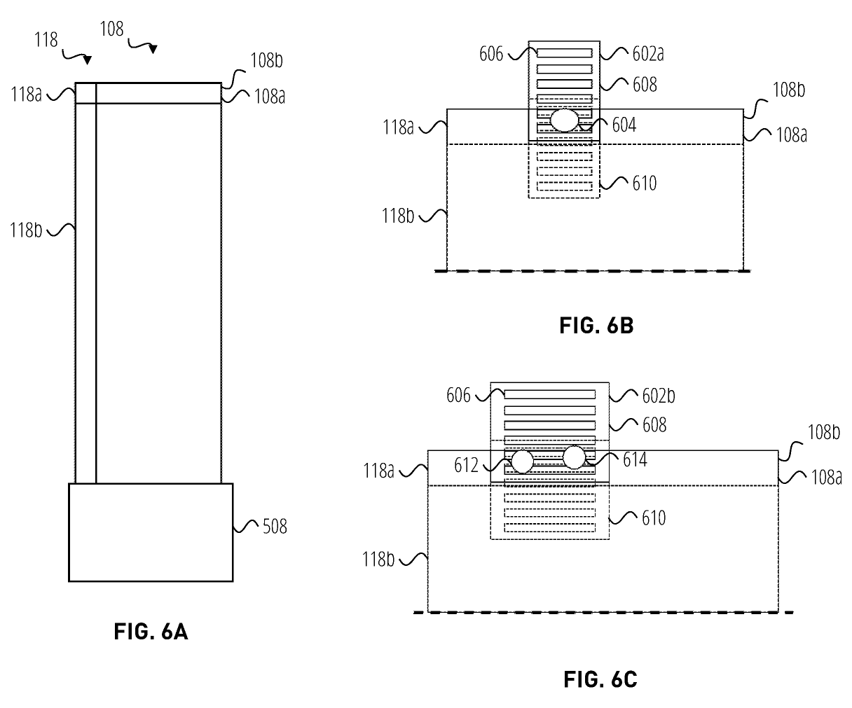

FIGS. 6A through 6C illustrate bend detectors 602a, 602b that can be used to detect a bend angle of a bend restrictor 118 in a radiation detector. FIG. 6A illustrates a detector stack 108, a bend restrictor 118, and an electronics board 508 when a flexible section of a radiation detector is in a neutral position and a bent position. First ends of the detector stack 108 and the bend restrictor 118 proximal the electronics board 508 can be fixed relative to the electronics board 508. Second ends of the detector stack 108 and the bend restrictor 118 distal the electronics board 508 can move relative to the electronics board 508. The links of the bend restrictor 118 can move closer together as the bend restrictor 118 bends, resulting in a length of the bend restrictor 118 decreasing as the flexible section bends. Thus, a length of the bend restrictor 118 in a neutral position 118a can be greater than a length of the bend restrictor 118 in a bent position 118b. A length of the detector stack 108 can remain substantially constant as the flexible section bends. Thus, a length of the detector stack 108 in a neutral position 108a can be substantially the same as a length of the detector stack 108 in a bent position 108b. The length of the bend restrictor 118 can decrease relative to the length of the detector stack 108 as the flexible section is bent.

A bend angle of the flexible section can be determined based on relative positions of ends of the bend restrictor 118 and the detector stack 108 opposite the electronics board 508. For example, as illustrated in FIG. 6B, a bend detector 602a can be coupled to an end of the bend restrictor 118 opposite the electronics board 508. A magnet 604 can be coupled to the end of the detector stack 108 opposite the electronics board 508. The bend detector 602a can include an array of sensors 606. The sensors 606 can include magnetic sensors or the like. The bend detector 602a can determine a position of an end of the detector stack 108 relative to the bend restrictor 118 based on a position of the magnet 604 relative to the bend detector 602a. The relative positions of the end of the detector stack 108 and the end of the bend restrictor 118 can then be used to determine the bend angle of the flexible section (including the detector stack 108 and the bend restrictor 118).

Although the bend detector 602a has been described in the context of a magnetic sensor, any suitable sensor can be used. For example, the bend detector 602a can include an optical sensor that can track a position of a reference feature on the detector stack 108, a force or tactile sensor that can track a position of contact between the detector stack 108 and the bend restrictor 118, or any other suitable sensor. Moreover, although the bend detector 602a has been described as being coupled to the bend restrictor 118 and the magnet 604 has been described as being coupled to the detector stack 108, positions of the bend detector 602a and the magnet 604 can be reversed.

In one or all examples, the detector stack 108 can be configured to slide into a handle housing of a radiation detector as a flexible section of the radiation detector bends. As such, a bend angle of the flexible section can also be determined by detecting a position of the detector stack 108 relative to the handle housing. For example, one of the bend detector 602a or the magnet 604 can be coupled to the handle housing and the other of the bend detector 602a or the magnet 604 can be coupled to the detector stack 108 in order to detect a position of the detector stack 108 relative to the handle housing. This detected position can then be used to determine a bend angle of the flexible section of the radiation detector.

FIG. 6C illustrates a bend detector 602b that provides a higher fidelity measurement of the relative positions of the detector stack 108 and the bend restrictor 118 as compared to the bend detector 602a of FIG. 6B. In the example of FIG. 6C, a first magnet 612 and a second magnet 614 are coupled to the detector stack 108 at positions that are horizontally and vertically offset from one another. Offsetting the positions of the first magnet 612 and the second magnet 614 allows for the bend detector 602b to provide more resolution or error correction to measurements provided by the bend detector 602b. In one or more examples, a vertical position of the first magnet 612 and the second magnet 614 can be offset by a distance that is about half the diameters of the first magnet 612 and the second magnet 614; however, any suitable offset can be used.

The bend detectors 602a, 602b can be used to track and predict a usable life of a radiation detector, such as by tracking a number of bends experienced by a flexible section of the radiation detector and how far the flexible section has been bent. Bending the flexible section to different degrees can impact an image detected by the radiation detector. The degree of bending of the flexible section detected by the bend detectors 602a, 602b during image detection can be used to provide different correction factors for image processing. The bend detectors 602a, 602b can be used with any of the bend restrictors disclosed herein.

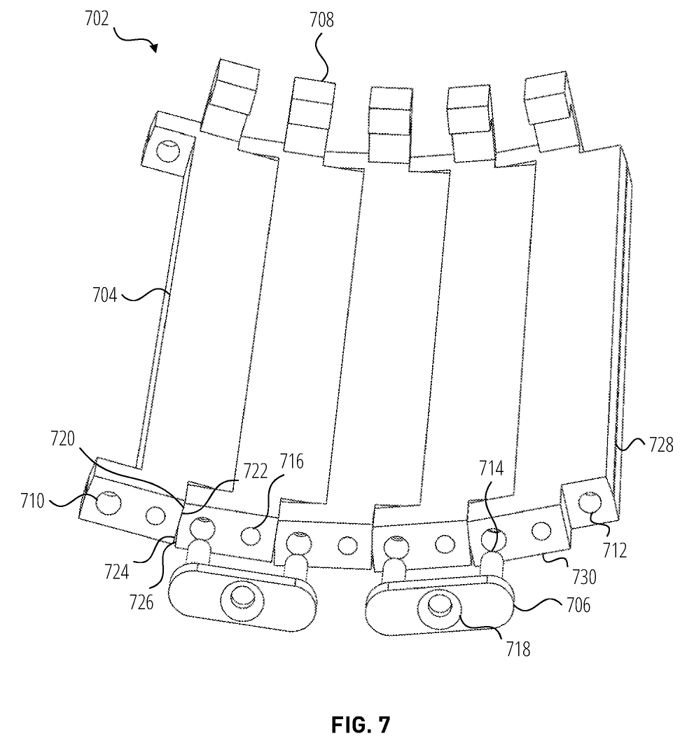

FIG. 7 illustrates a perspective, partially exploded view of a bend restrictor 702 according to one or more examples. The bend restrictor 702 can be used as the bend restrictor 118 for the radiation detector 100 in the example of FIGS. 1A through 6C. As illustrated in FIG. 7A, the bend restrictor 702 can include a plurality of inner links 704. Each of the inner links 704 can be coupled to adjacent inner links 704 by outer links 706. Each of the inner links 704 can include an inner portion 728 and two outer portions 730 positioned at opposite ends of the inner portion 728. The inner links 704 can be formed with or coupled to clips 708, which can be used to retain a detector stack relative to the bend restrictor 702. A first outer link 706 can be coupled to two adjacent inner links 704 at ends of the inner links 704 distal the clips 708 and a second outer link 706 can be coupled to the two adjacent inner links 704 at ends of the inner links 704 proximal the clips 708.

Each of the inner links 704 can include openings 710 and openings 712 configured to receive protrusions 714 of the outer links 706. The openings 710 can extend through outer portions 730 of the inner links 704. The openings 712 can be formed in inner portions 728 of the inner links 704. Each of the protrusions 714 can extend through an opening 710 in a first inner link 704 (e.g., through an outer portion 730 of the first inner link 704) and into an opening 712 in an adjacent second inner link 704 (e.g., into an inner portion 728 of the second inner link 704). The protrusions 714 inserted into the openings 710, 712 can allow the outer links 706 and the inner links 704 to rotate relative to one another.

The inner links 704 can further include openings 716 and the outer links 706 can include openings 718 configured to receive fasteners (e.g., screws, bolts, pins, or the like) to mechanically couple the outer links 706 to the inner links 704. The openings 718 can extend through the outer links 706. The openings 716 can extend at least partially through the outer portions 730 and can extend at least partially into or through the inner portions 728 of the inner links 704. The configuration of FIG. 7 can allow for the inner links 704 and the outer links 706 to be fastened to one another by a reduced number of fasteners and by fasteners with reduced lengths, which can reduce a part count and weight of the bend restrictor 702. Further, the configuration of FIG. 7 can allow for easier serviceability of components of the bend restrictor 702.

In the example of FIG. 7, interference between surfaces of adjacent inner links 704 can limit the degree of concave and convex bending allowed by the bend restrictor 702. For example, interference between a forward upper surface 720 of a first inner link 704 and a rearward upper surface 722 of a second inner link 704 adjacent (e.g., to the right in FIG. 7) to the first inner link 704 can limit bending allowed by the bend restrictor 702 in a concave direction (e.g., upwards in FIG. 7). Interference between a forward lower surface 724 of the first inner link 704 and a rearward lower surface 726 of the second inner link 704 adjacent (e.g., to the right in FIG. 7) to the first inner link 704 can limit bending allowed by the bend restrictor 702 in a convex direction (e.g., downwards in FIG. 7). Altering relative angles of the forward upper surface 720, rearward upper surface 722, forward lower surface 724, and rearward lower surface 726 and distances therebetween can be used to alter the degree of concave and convex bending allowed by the bend restrictor 702. In the example of FIG. 7, the surfaces 720, 722, 724, 726 that provide interference and bend limits between adjacent inner links 704 are positioned on the outer portions 730 of each of the inner links 704. In one or all examples, surfaces of the inner portions 728 of the inner links 704 can provide interference and bend limits between adjacent inner links 704 in addition to or in place of the surfaces 720, 722, 724, 726 of the outer portions 730.

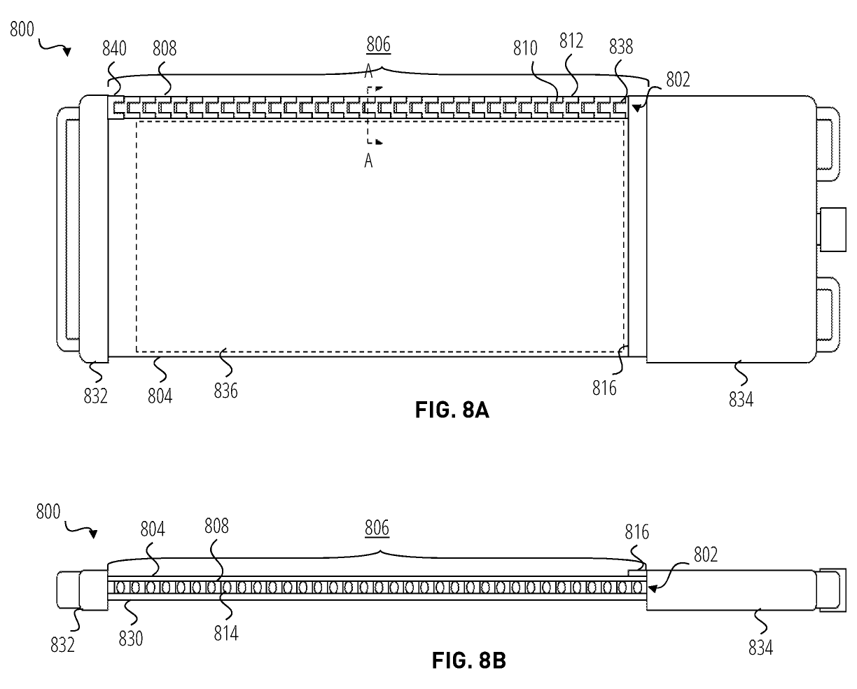

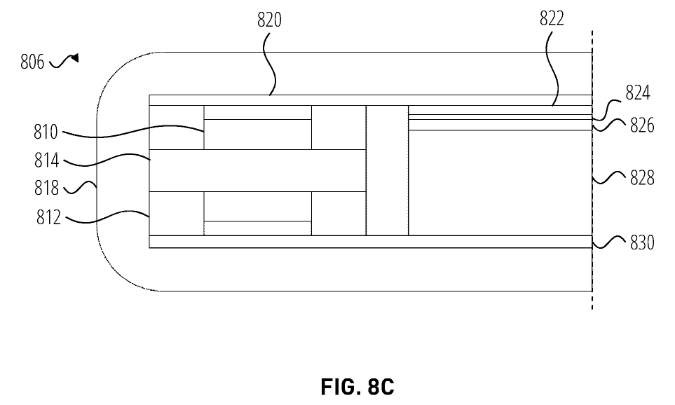

FIGS. 8A through 8C illustrate a radiation detector 800. The radiation detector 800 and components thereof can be the same as or similar to the radiation detector 100 discussed above with respect to FIGS. 1A through 3, except that the radiation detector 800 includes a bend restrictor 802 disposed along an edge of a detector stack 804. The bend restrictor 802 and the detector stack 804 can be part of or define a flexible section 806. FIG. 8A illustrates a top-down view of the radiation detector 800, FIG. 8B illustrates a side view of the radiation detector 800, and FIG. 8C illustrates a cross-sectional view of a portion of the detector stack 804 taken along the reference line A-A illustrated in FIG. 8A.

As illustrated in FIG. 8A, the radiation detector 800 includes the bend restrictor 802, which extends along a single side or edge of the detector stack 804. In the example of FIGS. 8A through 8C, the bend restrictor 802 can extend adjacent to the detector stack 804, without overlapping the detector stack 804. As will be discussed in greater detail below, the bend restrictor 802 can include a plurality of links 808, which each include an inner portion 810 configured to be received in an outer portion of an adjacent link 808. The links 808 can be fastened to one another by fasteners 814, which allow adjacent links 808 to rotate relative to one another. For example, as illustrated in FIG. 8C, a fastener 814 can extend through an outer portion 812 of a first link 808, through an inner portion 810 of an adjacent second link 808 and through another outer portion 812 of the first link 808 in order to couple the first and second links 808 to one another. Surfaces of adjacent links 808 can interface with one another to limit the degree of bending allowed by the bend restrictor 802.

The bend restrictor 802 does not overlap the detector stack 804 or extend between opposite sides of the detector stack 804, and therefore may provide less torsional stiffness relative to the bend restrictors 118, 702 discussed above. However, the bend restrictor 802 can have a smaller volume, reduced cost, and reduced weight relative to the bend restrictors 118, 702. Further, the detector stack 804 can include various components to add torsional stiffness and the like to the flexible section 806 of the radiation detector 800.

As illustrated in FIG. 8C, the detector stack 804 can include a front support plate 820, a scintillator 822, a sensor 824, a baseplate 826, a rear support plate 828, and a mounting plate 830. The bend restrictor 802 can be disposed adjacent to the detector stack 804. The front support plate 820 and the mounting plate 830 can at least partially overlap the bend restrictor 802. The front support plate 820, the scintillator 822, the sensor 824, the baseplate 826, and the rear support plate 828 can be the same as or similar to the front support plate 302, the scintillator 518, the sensor 520, the baseplate 522, and the rear support plate 306/rear support plate 524, discussed above. The sensor 824 can define an active area 836 of the detector stack 804. The flexible section 806 and the active area 836 can have dimensions the same as or similar to those discussed above with respect to the flexible section 102 and the active area 110.

The bend restrictor 802 can be coupled to the mounting plate 830. The mounting plate 830 can include an inner portion 838 to which an outer portion 812 of a link 808 of the bend restrictor 802 can be coupled by a fastener 814. The inner portion 838 can be the same as or similar to the inner portions 810 of the links 808. The mounting plate 830 can further include an outer portion 840 to which an inner portion 810 of a link 808 of the bend restrictor 802 can be coupled by a fastener 814. The outer portion 840 can be the same as or similar to the outer portions 812 of the links 808. The inner portion 838 and the outer portion 840 can include surfaces that can interface with surfaces of the links 808 in order to limit the degree of bending allowed by the bend restrictor 802. The bend restrictor 802 can be coupled to the mounting plate 830 such that the links 808 of the bend restrictor 802 can rotate relative to the mounting plate 830. In other words, the bend restrictor 802 can be rotatably coupled to the mounting plate 830.

The mounting plate 830 can be coupled to an electronics housing 834 and a handle housing 832 of the radiation detector 800. The mounting plate 830 can be provided to mount the bend restrictor 802 to other components of the radiation detector 800 and to increase a stiffness or rigidity of the flexible section 806. The mounting plate 830 can be formed from materials having a desired level of stiffness, flexibility, and elasticity, while having a minimal density. For example, the mounting plate 830 can be formed from metals, such as aluminum or steel; carbon fiber; plastic materials; polymer materials; fiberglass; an epoxy resin; or the like. A retainer 816 can be coupled to the mounting plate 830, through components of the detector stack 804 in order to couple the detector stack 804 to the electronics housing 834 and the handle housing 832. The retainer 816 can be the same as or similar to the retainer 130, discussed above.

The bend restrictor 802 and the detector stack 804 can be surrounded by a sleeve 818, which can protect components of the bend restrictor 802 and the detector stack 804 from contaminants and other damage. The sleeve 818 can be formed from materials the same as or similar to the sleeve 504, discussed above. Providing the sleeve 818 surrounding both the bend restrictor 802 and the detector stack 804 can prevent damage to the bend restrictor 802, prevent contaminants from jamming the bend restrictor 802, and provide the radiation detector 800 with cleaner aesthetics. However, providing bend restrictors outside of protective sleeves can result in a smaller overall size, prevent stretching issues in the protective sleeve, reduce the complexity of assembly and repair of the radiation detector, and the like.

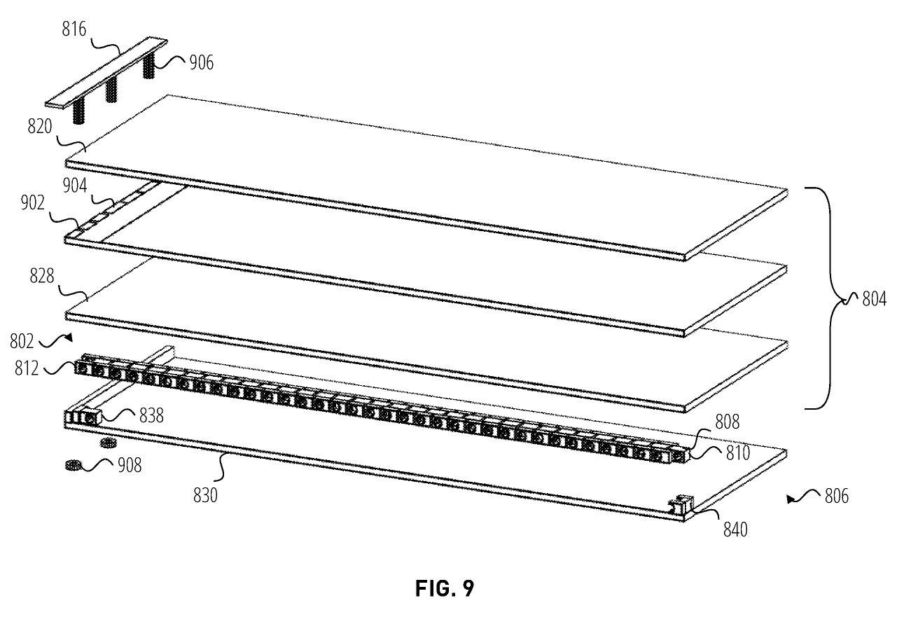

FIG. 9 illustrates an exploded view of a stack-up for the flexible section 806 of the radiation detector 800. As illustrated in FIG. 9, the detector stack 804 of the radiation detector 800 can include a front support plate 820, a sensor array 902, and a rear support plate 828. The sensor array 902 can include the sensor 824 and the baseplate scintillator 822, discussed above with respect to FIGS. 8A through 8C. Although not separately illustrated in FIG. 9, all of the components illustrated in FIG. 9 can be wrapped in a sleeve 818.

The sensor array 902 can be configured to generate an image in response to incident radiation. The sensor array 902 can define an active area of the detector stack 804 (e.g., the active area 836). The active area 836 can overlap the mounting plate 830 without mounting the links 808 that define the bend restrictor 802. The sensor array 902 can include a variety of sensors configured to generate data based on incident radiation. The sensor array 902 can include direct conversion sensors, indirect conversion sensors, photon counters, radiation conversion materials (e.g., scintillator materials), or the like. The sensor array 902 can include connectors 904, which can be used to couple the sensor array 902 to other components of a radiation detector, such as electronics boards and the like.

The front support plate 820 and the rear support plate 828 can be used to support the sensor array 902. The front support plate 820 can be formed a material having a low coefficient of friction and a high transparency to radiation. The front support plate 820 can prevent friction on an outward-facing surface of the sensor array 902. In one or all examples, the front support plate 820 can be formed from ultra-high-molecular-weight (UHMW) materials, such as polyethylene or the like. The rear support plate 828 can be formed from one or more layers of materials. The rear support plate 828 can be formed from materials having low transparency to radiation in order to prevent backscatter after radiation has passed through the sensor array 902. The rear support plate 828 can also be formed from materials having a low coefficient of friction and can prevent friction on a rear-facing surface of the sensor array 902. The rear support plate 828 can include a tungsten rubber material, a UHMW material, such as polyethylene, layers thereof, or the like.

The retainer 816 can include bolts 906, or bolts can be inserted through or coupled to the retainer 816. The bolts can extend through openings in the front support plate 820, the sensor array 902, the rear support plate 828, and the mounting plate 830, and nuts 908 can be threaded onto the bolts 906. The retainer 816 can thus use the bolts 906 and the nuts 908 to secure the components of the flexible section 806 to one another. Although the retainer 816 has been described as including the bolts 906 and the nuts 908, any suitable fasteners can be used to couple the components of the flexible section 806 to one another.

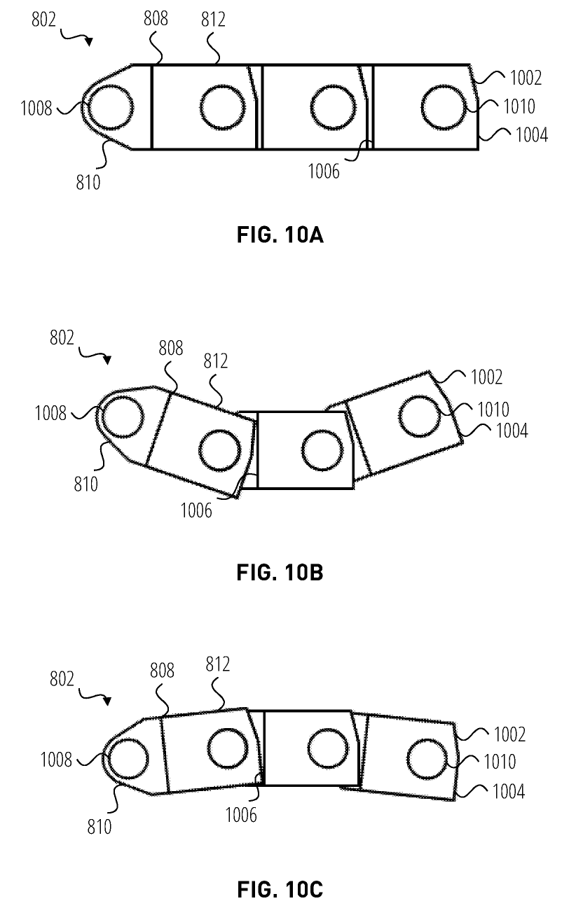

FIGS. 10A through 10C illustrate side views of a portion of the bend restrictor 802. FIG. 10A illustrates the bend restrictor 802 in a neutral position, FIG. 10B illustrates the bend restrictor 802 in a concave position, and FIG. 10C illustrates the bend restrictor 802 in a convex position. As illustrated in FIGS. 10A through 10C, each of the links 808 of the bend restrictor 802 can include an inner portion 810, an outer portion 812, a forward upper surface 1002, a forward lower surface 1004, and a rearward surface 1006. Each of the forward upper surface 1002, the forward lower surface 1004, and the rearward surface 1006 can be formed on the outer portions 812 of the links 808. An opening 1008 can be formed through the inner portion 810 of each link 808 and two openings 1010 can be formed through the outer portions 812 of each link 808. Fasteners can be provided through a first opening 1010 of a first link 808, through an opening 1008 of an adjacent second link 808, and through a second opening 1010 of the first link 808 in order to couple adjacent links 808 to one another, while allowing the links 1102 to rotate relative to one another.

As illustrated in FIG. 10B, when the bend restrictor 802 is bent in a concave direction (e.g., upwards in FIG. 10B), interference between a forward upper surface 1002 of a first link 808 and a rearward surface 1006 of a second link 808 adjacent (e.g., to the right in FIG. 10B) to the first link 808 can limit bending allowed by the bend restrictor 802 in the concave direction . Similarly, as illustrated in FIG. 10C, when the bend restrictor 802 is bent in a convex direction (e.g., downwards in FIG. 10C), interference between a forward lower surface 1004 of the first link 808 and a rearward surface 1006 of the second link 808 adjacent (e.g., to the right in FIG. 10C) to the first link 808 can limit bending allowed by the bend restrictor 802 in the convex direction. Altering relative angles of the forward upper surface 1002, the forward lower surface 1004, and the rearward surface 1006 and distances therebetween can be used to alter the degree of concave and convex bending allowed by the bend restrictor 802. Moreover, the rearward surface 1006 can include two angled surfaces to further customize the bending limits provided by the bend restrictor 802.

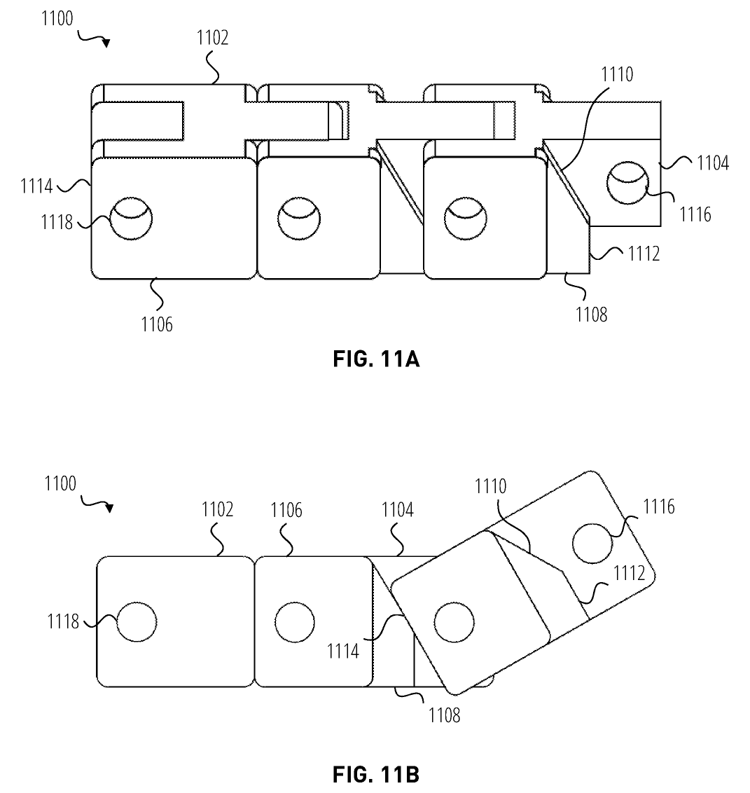

FIGS. 11A and 11B illustrate a portion of a bend restrictor 1100 that can be used in place of the bend restrictor 802 in the example illustrated in FIGS. 8A through 9. FIG. 11A illustrates the bend restrictor 1100 in a neutral position and FIG. 11B illustrates the bend restrictor 1100 in a concave position. As illustrated in FIGS. 11A and 11B, the bend restrictor 1100 can include a plurality of links 1102. Each of the links 1102 can include an inner portion 1104, an outer portion 1106, and an intermediate portion 1108. The intermediate portion 1108 can define a forward upper surface 1110 and a forward lower surface 1112. The outer portion 1106 can define a rearward surface 1114. An opening 1116 can be formed through the inner portion 1104 of each link 1102 and two openings 1118 can be formed through the outer portions 1106 of each link 1102. Fasteners can be provided through a first opening 1118 of a first link 1102, through an opening 1116 of an adjacent second link 1102, and through a second opening 1118 of the first link 1102 in order to couple adjacent links 1102 to one another, while allowing the links 1102 to rotate relative to one another.

As illustrated in FIG. 11B, when the bend restrictor 1100 is bent in a concave direction (e.g., upwards in FIG. 11B), interference between a forward upper surface 1110 of a first link 1102 and a rearward surface 1114 of a second link 1102 adjacent (e.g., to the right in FIG. 11B) to the first link 1102 can limit bending allowed by the bend restrictor 1100 in the concave direction . Similarly, when the bend restrictor 1100 is bent in a convex direction (e.g., downwards in FIG. 11B), interference between a forward lower surface 1112 of the first link 1102 and a rearward surface 1114 of the second link 1102 adjacent (e.g., to the right in FIG. 11B) to the first link 1102 can limit bending allowed by the bend restrictor 1100 in the convex direction. Altering relative angles of the forward upper surface 1110, the forward lower surface 1112, and the rearward surface 1114 and distances therebetween can be used to alter the degree of concave and convex bending allowed by the bend restrictor 1100. Moreover, the rearward surface 1114 can include two angled surfaces to further customize the bending limits provided by the bend restrictor 1100.

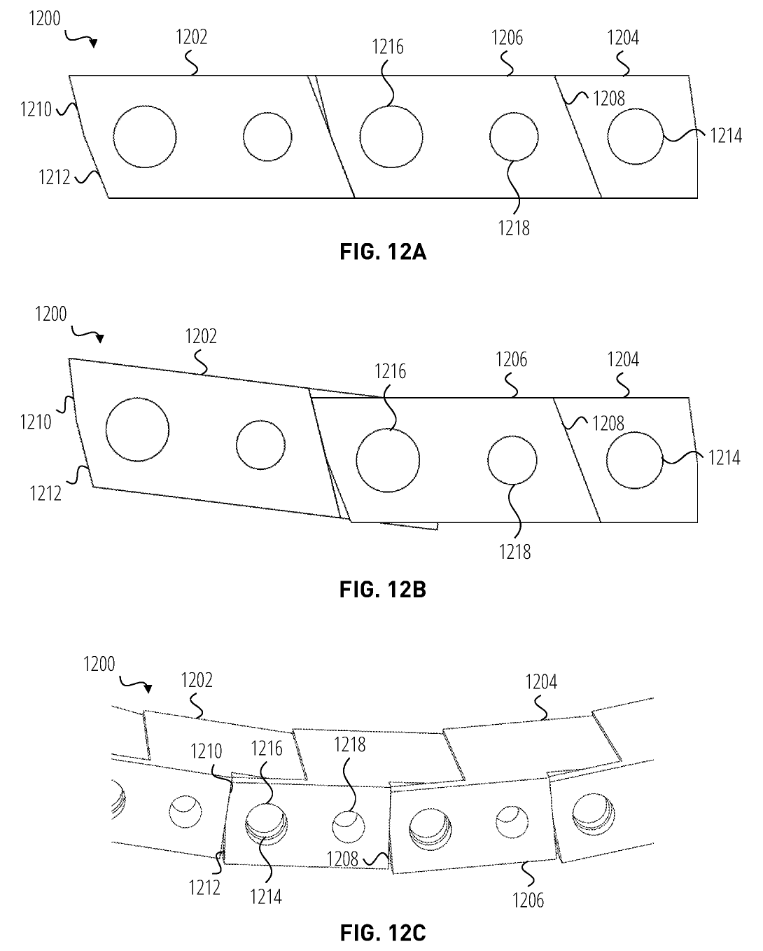

FIGS. 12A through 12C illustrate portions of a bend restrictor 1200 that can be used in place of the bend restrictor 802 in the example illustrated in FIGS. 8A through 9. FIG. 12A illustrates a side view of the bend restrictor 1200 in a neutral position. FIG. 12B illustrates a side view of the bend restrictor 1200 in a concave position. FIG. 12C illustrates a perspective view of the bend restrictor 1200 in the concave position. As illustrated in FIGS. 12A through 12C, the bend restrictor 1200 can include a plurality of links 1202. Each of the links 1202 can include an inner portion 1204 and an outer portion 1206. The outer portion 1206 can define a forward surface 1208, a rearward upper surface 1210, and a rearward lower surface 1212. The bend restrictor 1200 can be configured and can operate similarly to the bend restrictor 702, discussed above with respect to FIG. 7.

Each of the links 1202 can include an opening 1214 and an opening 1216. The openings 1214, 1216 can be configured to receive protrusions of an outer link, which can be used to couple each of the links 1202 to adjacent links 1202. The links 1202 can be coupled to one another by outer links that can be the same as or similar to the outer links 706, discussed above with respect to FIG. 7. Each opening 1214 can extend at least partially into or through the inner portion 1204 of a link 1202. Each opening 1216 can extend through the outer portion 1206 of a link 1202. The protrusions of the outer links can extend through an opening 1216 in a first link 1202 (e.g., through an outer portion 1206 of the first link 1202) and into an opening 1214 in an adjacent second link 1202 (e.g., into an inner portion 1204 of the second link 1202). The protrusions inserted into the openings 1214, 1216 can allow the links 1202 (and outer links coupled thereto) to rotate relative to one another.

The links 1202 can further include openings 1218 configured to receive fasteners (e.g., screws, bolts, pins, or the like) to mechanically couple the outer links to the links 1202. The openings 1218 can extend at least partially through the outer portions 1206 and can extend at least partially into or through the inner portions 1204 of the links 1202. The configuration of FIGS. 12A through 12C can allow for the links 1202 and the outer links to be fastened to one another by a reduced number of fasteners and by fasteners with reduced lengths, which can reduce a part count and weight of the bend restrictor 1200. Further, the configuration of FIGS. 12A through 12C can allow for easier serviceability of components of the bend restrictor 1200.

In the example of FIGS. 12A through 12C, interference between surfaces of adjacent links 1202 can limit the degree of concave and convex bending allowed by the bend restrictor 1200. For example, as illustrated in FIGS. 12B and 12C, interference between a forward surface 1208 of a first link 1202 and a rearward upper surface 1210 of a second link 1202 adjacent (e.g., to the right in FIGS. 12A through 12C) to the first link 1202 can limit bending allowed by the bend restrictor 1200 in a concave direction (e.g., upwards in FIGS. 12A through 12C). Interference between the forward surface 1208 of the first link 1202 and a rearward lower surface 1212 of the second link 1202 adjacent (e.g., to the right in FIGS. 12A through 12C) to the first link 1202 can limit bending allowed by the bend restrictor 1200 in a convex direction (e.g., downwards in FIGS. 12A through 12C). Altering relative angles of the forward surface 1208, the rearward upper surface 1210, and the rearward lower surface 1212 and distances therebetween can be used to alter the degree of concave and convex bending allowed by the bend restrictor 1200. In the example of FIGS. 12A through 12C, the surfaces 1208, 1210, 1212 that provide interference and bend limits between adjacent links 1202 are positioned on the outer portions 1206 of each of the links 1202. In one or all examples, surfaces of the inner portions 1204 of the links 1202 can provide interference and bend limits between adjacent links 1202 in addition to or in place of the surfaces 1208, 1210, 1212 of the outer portions 1206.

As illustrated in FIGS. 12A through 12C, each of the forward surface 1208, the rearward upper surface 1210, and the rearward lower surface 1212 can be arranged at oblique angles relative to the links 1202. This can improve the stiffness of the bend restrictor 1200 and reduce misalignment between adjacent links 1202 as the bend restrictor 1200 is assembled and used. Any of the interference surfaces described herein can be defined at oblique angles relative to the respective links in order to achieve similar improvements in the stiffness of bend restrictors and reductions in misalignments.

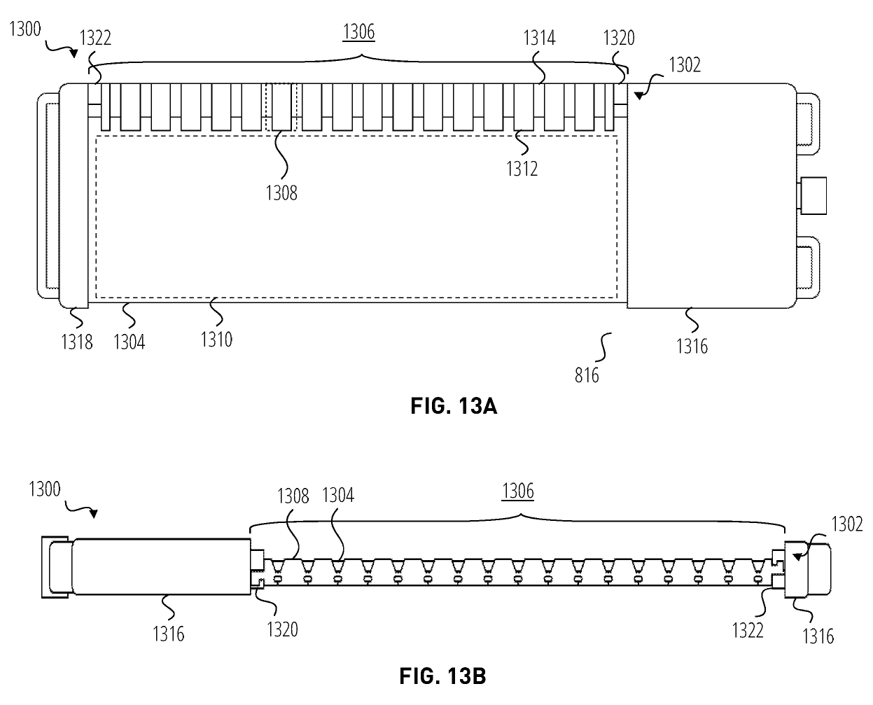

FIGS. 13A and 13B illustrate a radiation detector 1300. The radiation detector 1300 and components thereof can be the same as or similar to the radiation detectors 100, 800, discussed above, except that the radiation detector 1300 includes a living-hinge type bend restrictor 1302 disposed along an edge of a detector stack 1304. The bend restrictor 1302 and the detector stack 1304 can be part of or define a flexible section 1306 of the radiation detector 1300. The flexible section 1306 and an active area 1310 of the detector stack 1304 can have dimensions the same as or similar to those discussed above with respect to the flexible section 102 and the active area 110. FIG. 13A illustrates a top-down view of the radiation detector 1300 and FIG. 13B illustrates a side view of the radiation detector 1300.

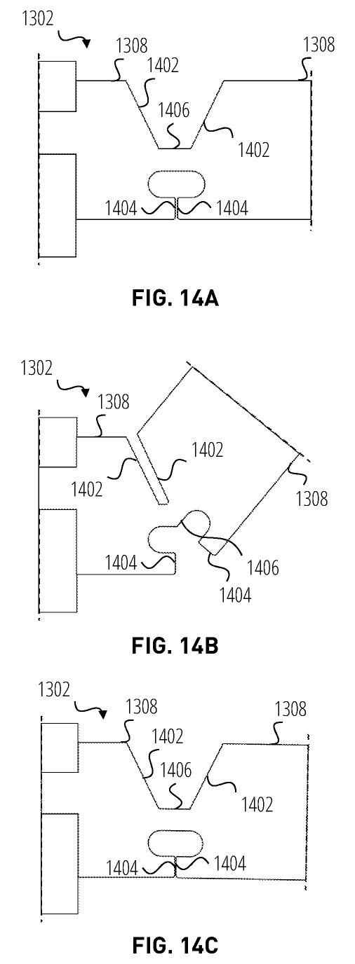

As illustrated in FIG. 13A, the radiation detector 1300 includes the bend restrictor 1302, which extends along a single side or edge of the detector stack 1304. The bend restrictor 1302 can be coupled to the detector stack 1304 (e.g., to an exterior surface of a sleeve of the detector stack 1304). The bend restrictor 1302 can include a plurality of links 1308, which are formed from a flexible material. Flexible materials that can be used for the links 1308 of the bend restrictor 1302 can include polymers, plastics, rubbers, elastomers, combinations thereof, or the like. The links 1308 can be formed from a single continuous material, and can be coupled to one another by the single continuous material. As will be discussed in detail below with respect to FIGS. 14A through 14C, the links 1308 can include surfaces that provide hard stops and interference in order to limit bending of the bend restrictor 1302 and the flexible section 1306 in a concave direction and a convex direction.

The links 1308 can be C-shaped in a cross-sectional view perpendicular to a longitudinal axis of the flexible section 1306, and can extend at least partially along a top surface and/or a bottom surface of the detector stack 1304. For example, as illustrated in FIG. 13A, the links 1308 can extend at least partially along a top surface of the detector stack 1304, outside of an active area 1310 of the detector stack 1304. The links 1308 can further extend at least partially along a bottom surface of the detector stack 1304 opposite the top surface. Overlapping the links 1308 and the detector stack 1304 can provide increased stiffness and rigidity to the bend restrictor 1302, especially torsional stiffness and rigidity. The links 1308 can each include inner portions 1312, which can at least partially overlap the detector stack 1304 outside of the active area 1310, and outer portions 1314, which can extend alongside and outside of the detector stack 1304. The detector stack 1304 can include additional baseplates (e.g., similar to or the same as the baseplates 522, discussed above) or the like to further increase the stiffness and rigidity of the flexible section 1306.

The links 1308 of the bend restrictor 1302 can be coupled to an electronics housing 1316 of the radiation detector 1300 by an electronics-side anchor 1320 and can be coupled to a handle housing 1318 of the radiation detector 1300 by a handle-side anchor 1322. The electronics-side anchor 1320 can be part of or coupled to the electronics housing 1316. For example, the electronics-side anchor 1320 can be formed by an upper portion of a housing of the electronics housing 1316 and a lower portion of the housing of the electronics housing 1316. The upper portion and the lower portion of the housing of the electronics housing 1316 can be joined to one another such that the bend restrictor 1302 is sandwiched between the upper portion and the lower portion of the housing of the electronics housing 1316 in the electronics-side anchor 1320. In one or all examples, the bend restrictor 1302 can be molded into the electronics-side anchor 1320. Similarly, the handle-side anchor 1322 can be formed by an upper portion of a housing of the handle housing 1318 and a lower portion of the housing of the handle housing 1318. The upper portion and the lower portion of the housing of the handle housing 1318 can be joined to one another such that the bend restrictor 1302 is sandwiched between the upper portion and the lower portion of the housing of the handle housing 1318 in the handle-side anchor 1322. In one or all examples, the bend restrictor 1302 can be molded into the handle-side anchor 1322. As illustrated in FIG. 13B, the electronics-side anchor 1320 and the handle-side anchor 1322 can form recesses, which can retain protrusions of the bend restrictor 1302. The bend restrictor 1302 can be molded to have a shape corresponding to recesses formed in the electronics-side anchor 1320 and the handle-side anchor 1322.

FIGS. 14A through 14C illustrate side views of a portion of the bend restrictor 1302. FIG. 14A illustrates the bend restrictor 1302 in a neutral position, FIG. 14B illustrates the bend restrictor 1302 in a concave position, and FIG. 14C illustrates the bend restrictor 1302 in a convex position. As illustrated in FIGS. 14A through 14C, each of the links 1308 of the bend restrictor 1302 can include an upper surface 1402 and a lower surface 1404. Each of the links 1308 can be coupled to adjacent links 1308 by bridge portions 1406 formed between the links 1308. Thus, the bend restrictor 1302 can include a single continuous material that connects each of the links 1308 of the bend restrictor 1302.

As illustrated in FIG. 14B, when the bend restrictor 1302 is bent in a concave direction (e.g., upwards in FIG. 14B), the bridge portions 1406 between adjacent links 1308 bend and interference between upper surfaces 1402 of adjacent links 1308 provides a hard stop to limit bending allowed by the bend restrictor 1302 in the concave direction. Similarly, as illustrated in FIG. 14C, when the bend restrictor 1302 is bent in a convex direction (e.g., downwards in FIG. 14C), the bridge portions 1406 between adjacent links 1308 bend and interference between lower surfaces 1404 of adjacent links 1308 provides a hard stop to limit bending allowed by the bend restrictor 1302 in the convex direction. Altering relative angles of the upper and lower surfaces 1402, 1404 and distances therebetween can be used to alter the degree of concave and convex bending allowed by the bend restrictor 1302. The upper and lower surfaces 1402, 1404 can be defined in the outer portions 1314 of the bend restrictor 1302.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A radiation detector comprising:
an imaging array configured to detect incident radiation in an active area; and
a bend restrictor coupled to the imaging array, wherein the bend restrictor at least partially overlaps the active area.

2. The radiation detector of claim 1, wherein the bend restrictor extends past a first edge of the imaging array and a second edge of the imaging array opposite the first edge in a direction perpendicular to the first and second edges.

3. The radiation detector of claim 1, wherein the bend restrictor comprises a plurality of clips configured to retain the imaging array in a first direction and allow the imaging array to translate in a second direction perpendicular to the first direction.

4. The radiation detector of claim 1, wherein the bend restrictor comprises a plurality of links, each of the links comprising:
a first surface configured to restrict bending of the imaging array in a concave direction; and
a second surface configured to restrict bending of the imaging array in a convex direction.

5. The radiation detector of claim 1, further comprising:
an electronics housing comprising an electronics board coupled to the imaging array, wherein the imaging array is fixed relative to the electronics housing; and
a handle housing coupled to the imaging array opposite the electronics housing, wherein the imaging array is configured to translate relative to the handle housing.

6. The radiation detector of claim 5, further comprising a seal surrounding the imaging array, the seal comprising:
a fixed seal coupled to the electronics housing; and
a sliding seal coupled to the handle housing.

7. The radiation detector of claim 1, wherein the bend restrictor comprises:
a first plurality of outer links on a first side of the imaging array;
a second plurality of outer links on a second side of the imaging array; and
a plurality of inner links coupled to the first plurality of outer links and the second plurality of outer links.

8. The radiation detector of claim 7, wherein the inner links have a length equal to or greater than a width of the imaging array between the first side and the second side.

9. The radiation detector of claim 7, wherein the bend restrictor further comprises a plurality of pins configured to couple the first plurality of outer links and the second plurality of outer links to one another, each of the pins comprising:
a first protrusion configured to extend into a first outer link;
a second protrusion configured to extend into a second outer link adjacent the first outer link; and
an opening configured to receive a fastener for securing the pin to the first outer link or the second outer link.

10. A radiation detector comprising:
a sensor stack;
a bend restrictor adjacent to the sensor stack; and
a seal surrounding the sensor stack and the bend restrictor.

11. The radiation detector of claim 10, wherein the bend restrictor comprises a plurality of links disposed outside of an active area of the sensor stack.

12. The radiation detector of claim 10, further comprising a support extending under the sensor stack and the bend restrictor, wherein the bend restrictor is rotatably coupled to the support.

13. The radiation detector of claim 10, wherein the bend restrictor comprises a plurality of links, each of the links comprising a first surface configured to restrict bending of the sensor stack in a first direction and a second surface configured to restrict bending of the sensor stack in a second direction opposite the first direction.

14. The radiation detector of claim 13, wherein the first surface and the second surface of each of the links extend in directions oblique to a longitudinal axis of the respective link.

15. The radiation detector of claim 13, wherein the bend restrictor further comprises a plurality of pins configured to couple the links to one another, each of the pins comprising:
a first protrusion configured to extend into a first link;
a second protrusion configured to extend into a second link adjacent the first link; and
an opening configured to receive a fastener for securing the pin to the first link or the second link.

16. A radiation detector comprising:
an electronics housing;
a handle housing;
a sensor array extending between the electronics housing and the handle housing; and
a bend restrictor coupled to the electronics housing and the handle housing, the bend restrictor at least partially overlapping the sensor array.

17. The radiation detector of claim 16, further comprising a sleeve configured to surround the sensor array and seal the sensor array to the electronics housing and the handle housing.

18. The radiation detector of claim 17, wherein the bend restrictor is coupled to an exterior surface of the sleeve.

19. The radiation detector of claim 16, wherein the bend restrictor overlaps a portion of the sensor array outside of an active area of the sensor array.

20. The radiation detector of claim 16, wherein the bend restrictor comprises a living hinge with hard stops that provide bend restriction in a first direction and a second direction opposite the first direction.
